(19) United States
(12) Patent Application Publication
(10) Pub. No.: US 2026/0140790 A1
(43) Pub. Date: May 21, 2026

(54) INTEGRATING AND CATALOGUING APPLICATION PROGRAMMING INTERFACES FOR NETWORK ENVIRONMENTS

(71) Applicant: CITIBANK, N.A., New York, NY (US)

(72) Inventors: Jaya C. CHILAKAMARRI, Irving, TX (US); David R. CHARLES, Irving, TX (US); Usha S. YELLAPU, Irving, TX (US); Miriam SILVER, Tel Aviv (IL)

(73) Assignee: CITIBANK, N.A., New York, NY (US)

(21) Appl. No.: 19/447,783

(22) Filed: Jan. 13, 2026

Related U.S. Application Data
(63) Continuation-in-part of application No. 19/329,236, filed on Sep. 15, 2025.
Application No. 19/329,236 is a continuation of application No. 18/626,911, filed on Apr. 4, 2024, now Pat. No. 12,450,107.
(60) Provisional application No. 63/467,201, filed on May 17, 2023.

(51) Int. Cl. G06F 9/54; G06F 11/34

(52) U.S. Cl. CPC G06F 9/541; G06F 9/54; G06F 9/547; G06F 11/3409; H04L 67/10

(57) ABSTRACT

Presented herein are system and methods for configuring data records of application programming interface (API) specifications for applications in network environments. A service may retrieve data associated with a first API for a first plurality of functions. The service may execute a generative model using the data associated with the first API to generate a first plurality of embeddings corresponding to a first API specification. The service may identify, from a database, a second plurality of embeddings corresponding to a second API specification for a second API that defines a second plurality of functions available for invocation to the one or more applications. The service may determine a redundancy between the first API specification and the second API specification using the first plurality of embeddings and the second plurality of embeddings. The service may select an API from one of the first API and the second API.

### CROSS REFERENCE TO RELATED APPLICATIONS

The present application claims the benefit of and priority to under 35 U.S.C. § 120 as a continuation-in-part of U.S. Application No. 19/329,236, titled “Integrating and Cataloguing Application Programming Interfaces for Network Environments,” filed September 15, 2025, which claims the benefit of and priority to under 35 U.S.C. § 120 as a continuation of U.S. Application No. 18/626,911, titled “Integrating and Cataloguing Application Programming Interfaces for Network Environments,” filed April 4, 2024, which claims the benefit of priority under present application claims the benefit of priority under 35 U.S.C. § 119(e) to U.S. Provisional Application No. 63/467,201, titled “Governing APIs with Intelligence,” filed May 17, 2023, each of which is incorporated herein in their entireties by reference.

### TECHNICAL FIELD

This application generally relates to application programming interfaces (APIs), and in particular, integrating and cataloguing APIs for use in network environments.

### BACKGROUND

One application may communicate with another application via an API. The API may include a set of rules and protocols to allow different applications to exchange data and interact with one another. Software developers may use the specified rules and protocols to access the functionality and data of one application from another application. There may be, however, several hindrances to adapting APIs. For instance, there may be inconsistencies in the API rules or protocols, with varying naming conventions, endpoints, and formats. In another example, documentation for APIs may be incomplete, outdated, or lacking, resulting in such APIs being unusable to the software developers. These and other hindrances may be even more exacerbated with the use of a myriad of APIs in network environments used by a multitude of users.

### SUMMARY

APIs may provide optionality to control access to data across a wide range of applications in a network environment (e.g., an organization or enterprise network or a cloud computing network), allowing developers to rapidly update applications to changing utilization and demands. Without proper management of the APIs, however, the entire network environment may be exposed through the APIs to security risks and other faults, such as data exfiltration or unauthorized access to various resources. Furthermore, the adoption of various APIs may eventually result in a sprawl of several APIs, with redundant APIs with overlapping functionalities, outdated API documentation, or orphan APIs without a clear managing entity, among others. Another challenge may include lack of interoperability or interfacing with records regarding the APIs available for use in the network.

API governance may be used to manage and administer the creation, deployment, and usage of APIs within complex network environments, addressing some of these challenges. The API governance may define a set of processes and policies to ensure that APIs are defined, deployed, and used in a consistent and secure manner by the applications and services in the network environments. There may be, however, a number of challenges in effectively enacting API governance. First, the API governance may lack any centralized system of record, resulting in ambiguities in API ownership and specifications and inadequate quality of API metadata. Second, there may be a lack of specific controls management, leading to frequent breaches in API controls, residual risks, and unauthorized use or access of sensitive information, among others. This may be particularly problematic when there are domain-specific policies (e.g., policies for different regions) applicable to the governance of APIs and related data. Third, the API governance may be deficient in lifecycle management through the entirety of the use of a given API, from development, deployment, versioning, and deprecation.

There may also be issues with other approaches for API governance, as these approaches do not have any method to semantically compare API specifications beyond path or name matching. This may make it difficult to detect when one API specification is a duplicate of another API specification. Even when a duplicate is noticed, there may also be no systematic method to evaluate or select between the overlapping APIs using any associated data about the APIs. Migration away from duplicate APIs via consolidation may require manual effort and be error‑prone. This may have the effect of discouraging cleanup, allowing redundant APIs to persist. The redundancies of APIs in the given network environment may lead to wasted computing resources and storage space due to storing and maintaining APIs that are potentially redundant and thus less used than the duplicative API.

To address these and other technical challenges, a centralized service for an API management platform may validate, test, integrate, and monitor APIs through their lifecycle by categorizing and aligning API specifications and identifying any redundancies and deprecations of APIs. The service may be a part of the network environment or separate from the network environment. The service may function as a single source of knowledge about APIs in the given network environment with the use of a robust API catalogue. By actively monitoring metadata and performance metrics of the APIs from the network, the service may update API records and update versioning. During the onboarding process, the service may also provide for codified controls and automated review. Through the lifecycle of a given API, the service may provide for automation and tooling for management, as well as observability into usage and analytics.

In registering an API, the service may collect data about an API, such as API specifications, gateway logs, and domain policies, from the network environment. When a new API is detected, the service may use a generative model (e.g., a large language model) to process the data. From processing the data using the generative model, the service may normalize the API specification by parsing the data into a canonical form. The service may create a data structure in a standardized form for the API specification with consistent field names and values. In addition, the service may identify a domain policy that is applicable to the API and add a tag indicating the applicable domain policy to the data structure. The service may also use the generative model to create a summarization of the API specification and to generate a set of embeddings that is a lower-dimensional encoded representation of the summarization output.

With the set of embeddings for the API specification, the service may search for other redundant API specifications. To identify, the service may compare a distance between the set of embeddings for the new API specification versus the set of embeddings for each candidate API specification. When the distance is within a threshold, the service may identify the new API as redundant in view of a previous API. Upon detecting multiple redundant APIs, the service may use the generative model to generate a score of the capabilities of each API and may select the API with the score indicative of the broadest capability. With the selection, the service may transmit information about the selected API specification as well as information about other candidate APIs for presentation via a user interface for a system administrator to confirm the selection. The information may include a side-by-side comparison of the APIs with an explanation for the selection of one of the APIs.

When approved, the service may integrate or deploy the API for use in the network environment by adding a record of the API in an API catalogue on a database. As the API is in use in the network environment, the service may collect and gather metadata about usage of the API and may update the record in the API catalogue on the database. For example, the service may determine whether a given API is deprecated or still in use in the network environment based on the metadata. Based on this determination, the service may update the record in the API catalogue for the API as deprecated or still in use.

By using the generative model, the service may combine normalization with semantic processing for the API specification, thereby providing a more complete and accurate definition of the API in a standardized, consistent format. The normalization may facilitate meaningful semantic comparisons of multiple API specifications and detection of redundant APIs in the network environment using embeddings representing the API specifications. In addition, the tagging of data structures for APIs may permit enforcement of domain policies of APIs in the network. The use of the generative model may also reduce or eliminate occurrences of redundant APIs, thereby saving computing resources and bandwidth that would have otherwise been consumed in invoking functions of redundant APIs.

In some embodiments, the service may provide a dashboard interface for an administrator device to submit a request for review of an API for a given domain (e.g., a type of function or application). The dashboard interface may include a set of fields for the administrator to enter information about the API, in accordance with a template for the given domain. The template may ensure that the API specifications are standardized and consistent. Upon submission through the dashboard interface, the service may select a policy against which to check the new API. With the selection, the service may perform validation and performance tests on the API. The service may generate a score card indicating which validation and performance tests the submitted API has passed or failed. With the generation, the service may provide the score card for presentation on the dashboard interface. This may allow the administrator or developer to revise the APIs using the score card provided on the dashboard. Until the API passes, the service may prohibit incorporation of the API into the network environment. One the API passes the tests, the API may be approved for use in the networked environment.

With the incorporation of the API for use, the service may add the specification of the API to the API catalogue for the network environment. The service may monitor for metadata associated with the API from a variety of data sources, including usage by applications and services within the network environment and revisions by the administrator through the API management platform, among others. Using the metadata, the service may update the corresponding record in the API catalogue for the API. For example, the service may identify whether a given version is in use or deprecated, when the metadata indicates a lack or reduction in usage of the API. The service may also determine whether there are redundancies with APIs by comparison the metadata across the APIs for similar functionality and usage. The service may calculate various performance metrics using the metadata associated with the API. The information derived from the metadata may be stored and maintained on the API catalogue.

Through the dashboard interface, the administrator device may submit a query for APIs from the API catalogue on the centralized service. With receipt, the service may search the API catalogue using the keywords of the query to find one or more APIs. The service may return an identification of the APIs for presentation on the dashboard interface on the administrator device. The service may also provide information derived from the metadata with the APIs, such as whether the version is in use, an indication of redundancy in function with another API, and performance analytics, among others, for the dashboard interface. This may allow the administrator or developer to have insight on the usage of APIs within the network environment.

In this manner, the service for an API management platform may provide for centralized records of APIs available for use in the network environment, thereby alleviating or eliminating issues surrounding API sprawl. The use of templates for API specifications may ensure consistency and standardization. By controlling integration of APIs into the network environment, the service may further ensure that the API specifications are successfully validated and tested prior to the integration. The continuous monitoring by the service may allow for lifecycle management of the APIs from development, deployment, versioning, and deprecation. The centralized catalogue may also provide a consistent and standardized information about APIs as well as performance metrics of the APIs used in the network environment. With the improvement in the API governance for the network environment, the computing resources and network bandwidth of the servers and clients in the network environment may be more efficiently allocated. Furthermore, new APIs may be deployed in a standard and consistent manner, thereby increasing the adaptation of newer functionality in the network environment.

Aspects of the present disclosure are directed to systems, methods, and non-transitory computer readable media for configuring data records of application programming interface (API) specifications for applications in network environments. One or more processors may retrieve data associated with a first API for a first plurality of functions available for invocation to one or more applications in the network environment. The one or more processors may execute a generative model using the data associated with the first API to generate a first plurality of embeddings corresponding to a first API specification that at least partially defines the first plurality of functions. The one or more processors may identify, from a database, a second plurality of embeddings corresponding to a second API specification for a second API that defines a second plurality of functions available for invocation to the one or more applications. The one or more processors may determine a redundancy between the first API specification and the second API specification using the first plurality of embeddings and the second plurality of embeddings. The one or more processors may select, responsive to determining the redundancy, an API from one of the first API and the second API based on a comparison between the first plurality of functions of the first API and the second plurality of functions of the second API. The one or more processors may configure, on the database, a data record identifying the API as permitted for use by the one or more applications in the network environment.

In one embodiment, the one or more processors may determine a lack of redundancy between a third API specification and a fourth API specification using a third plurality of embeddings corresponding to the third API specification and a fourth plurality of embeddings corresponding to the fourth API specification. The one or more processors may select, responsive to determining the lack of redundancy, the third API and the fourth API to permit for use in the network environment. The one or more processors may configure, on the database, a second data record identifying the third API and the fourth API as permitted for use in the network environment.

In another embodiment, the one or more processors may create, using the data associated with the first API, a data structure for the first API specification comprising a plurality of fields and a corresponding plurality of values in accordance with a canonical form, to define the first plurality of functions available for invocation to one or more applications; identify, from the plurality of fields of the data structure, a field corresponding to a missing value in the plurality of values; and generate, based on the data associated with the first API, a value corresponding to the field to include in the plurality of values, and store the data structure for the API specification.

In yet another embodiment, the one or more processors may create, using the data associated with the first API, an output comprising a summarization for the first API specification defining the first plurality of functions available for invocation to one or more applications via the first API; and generate the first plurality of embeddings corresponding to the summarization of the output. In yet another embodiment, the one or more processors may execute using the first plurality of embeddings and the second plurality of embeddings, a clustering model comprising a plurality of clusters defined within a feature space. The one or more processors may determine, based on executing the clustering model, (i) a first cluster assignment corresponding to at least one of the plurality of clusters for the first plurality of embeddings and (ii) a second cluster assignment corresponding to at least one of the plurality of clusters for the second plurality of embeddings. The one or more processors may determine the redundancy between the first API specification and the second API specification based on the first cluster assignment and the second cluster assignment.

In yet another embodiment, the one or more processors may generate, responsive to determining the redundancy, using the generative model, (i) a first score indicating capability of the first plurality of functions of the first API and (ii) a second score indicating capability of the second plurality of functions of the second API. The one or more processors may select the API from one of the first API and the second API based the comparison between the first score and the second score. In yet another embodiment, the one or more processors may generate, using the generative model, (i) first information corresponding to the first API specification and (ii) second information corresponding to the second API specification. The one or more processors may provide, via a user interface, at least one of (i) a first interface element to present the first information or (ii) a second interface element to present the second information.

In yet another embodiment, the one or more processors may identify a domain policy defining applicability of the API specification to a region in the network environment. The one or more processors may generate, in accordance with the domain policy, a tag to include with a data structure for the API specification to define the applicability to the region. The one or more processors may update based on executing the generative model using the tag, one or more values in the data structure. The one or more processors may configure the data record identifying the API as permitted for use in the region in accordance with the domain policy.

In yet another embodiment, the one or more processors may generate, based on executing the generative model using the API specification, (i) a test schema defining a test case for at least one function of a plurality of functions of the API and (ii) test data with which to evaluate the test case. The one or more processors may execute, in accordance with the test schema, the test case to invoke the at least one function using the test data to generate a data result. The one or more processors may store, on the database, an association between the test result and the data record for the API. In yet another embodiment, the one or more processors may retrieve the data comprising at least one of: (i) at least a portion of the first API specification, (ii) a transaction log for invocation of the first plurality of functions, or (iii) a domain policy.

Aspects of the present disclosure are directed to systems, methods, and non-transitory computer readable media for integrating application programming interfaces (APIs) for use in network environments. A service of an API management platform may receive, from an administrator device, a request to deploy an API for use in a network environment among one or more applications. The request may include a specification defining the API according to a template for a domain of a plurality of domains. The service may identify, from a plurality of policies corresponding to the plurality of domains, a policy based on the domain for the template with which the specification of the request is defined. The service may determine that the API is validated in accordance with the policy for the domain. The service may generate an indication of approval of the API for use in the network environment among the one or more applications, responsive to determining that the API is validated. The service may store, on a database of the API management platform, an association between the specification of the API and the indication of approval to permit use of the API in the network environment.

In one embodiment, the service may determine that a second API is not validated in accordance with the policy for the domain. The service may generate a second indication of disapproval of the second API for use in the network environment among the one or more applications, responsive to determining that the second API is not validated. The service may store, on the database, an association between the second API and the second indication of disapproval to restrict use of the second API in the network environment. In another embodiment, the service may provide, for presentation via a user interface on the administrator device, the second indication of disapproval of the second API for use in the network environment among the one or more applications. In yet another embodiment, the service may determine that the second API is not validated in accordance with at least one of a subset of policies for the domain. The service may identify, from the subset of policies, a second policy under which the API is not validated, while the API is validated under a remainder of the subset of policies. The service may generate the second indication identifying the second policy under which the API is not validated.

In yet another embodiment, the service may provide, for presentation on the administrator device, a user interface comprising a plurality of user interface elements to accept information for defining the API in accordance with the template for the domain. The service may receive the request including the specification generated using the information accepted via one or more of the plurality of user interface elements of the user interface presented on the administrator device. In yet another embodiment, the service may determine that the API satisfies a functionality criterion based on testing of the API defined by the specification. The service may generate the indication further comprises generating the indication of approval, responsive to determining (i) that the API is validated and (ii) that the API satisfied the functionality criterion.

In yet another embodiment, the service may determine that the API is validated further comprises determining that the API is validated in accordance with all of a subset of policies for the domain. The service may generate a validation score based on determining that the API is validated in accordance with one or more of the subset of policies. In yet another embodiment, the service may provide, for presentation via a user interface on the administrator device, the indication of approval of the API for use in the network environment among the one or more applications. In yet another embodiment, the service may maintain, on the database, a plurality of templates for the corresponding plurality of domains to define APIs. Each domain of the plurality of domains may define a respective type of application for the APIs. In yet another embodiment, the service may perform an integration on the API to be used by the one or more applications of the network environment, responsive to storing the association on the database.

Aspects of the present disclosure are directed to systems, methods, and non-transitory computer readable media for cataloguing application programming interfaces (APIs) using metadata. A service may be associated with an API management platform. The service may maintain, a plurality of records on a database. Each record of the plurality of records may identify a respective API of a plurality of APIs approved in use in a network environment among one or more applications. The service may retrieve, for at least one API of the plurality of APIs, metadata identifying at least one of (i) usage of the at least one API from the network environment or (ii) modification of a specification of the at least one API via the API management platform. The service may update, on the database, a respective record of the plurality of records for the at least one API using the metadata. The service may receive, from an administrator device, a query including one or more keywords to select one or more of the plurality of records on the database. The service may select from the plurality of records on the database, the respective record identifying the at least one API based on the one or more keywords of the query and the metadata associated with the at least one API. The service may transmit, to the administrator device, a response identifying the respective record for the at least one API.

In one embodiment, the service may generate a plurality of performance metrics for the at least one API, using the metadata identifying usage of the at least one API in the network environment. The service may provide, for presentation via a user interface on an administrator device, the plurality of performance metrics for the at least one API. In another embodiment, the service may determine that the at least one API is redundant with a second API of the plurality of APIs based on metadata of the at least API and second metadata of the second API. The service may update the respective record to indicate that the at least one API is redundant with the second API.

In yet another embodiment, the service may determine that a first version of the at least one API is deprecated based on the usage of the first version of the at least one API in the network environment below a threshold. The service may update the respective record to indicate that the version of the at least one API is deprecated. In yet another embodiment, the service may identify, from a plurality of classification, a classification for the at least one API based on the metadata. The service may update the respective record to identify the classification for the least one API.

In yet another embodiment, the service may generate a graph identifying a plurality of nodes and a plurality of edges using the metadata associated with the at least one API. Each of the plurality of nodes may correspond to a respective element of the metadata. Each of the plurality of edges may define a relationship between a corresponding pair of nodes of the plurality of nodes. The service may update the respective record to include the graph for the at least one API. In yet another embodiment, the service may maintain the plurality of records each identifying at least one of a plurality of domains under which the respective API is approved for use in the network environment. The service may receive the query identifying a domain of the plurality of domains. The service may select the at least one record based on the domain identified in the query.

In yet another embodiment, the service may receive, via a user interface from the administrator device, the query generated using information accepted via one or more user interface elements of the user interface presented on the administrator device. In yet another embodiment, the service may provide, for presentation via a user interface on the administrator device, an identification corresponding to the respective record for the at least one API. In yet another embodiment, the service associated with the API management platform may reside in at least one of: (i) within the network environment or (ii) outside the network environment.

It is to be understood that both the foregoing general description and the following detailed description are exemplary and explanatory and are intended to provide further explanation of the embodiments described herein.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates a block diagram of a process for automation of application programming interface (API) governance across API life cycles, in accordance with an embodiment;

FIG. 2 illustrates a block diagram of a system for managing application programming interfaces (APIs) in network environments, in accordance with an embodiment;

FIG. 3 illustrates a block diagram of a system for detecting application programming interfaces (APIs) for use in network environments, in accordance with an embodiment;

FIG. 4 illustrates a block diagram of a system for integrating application programming interfaces (APIs) for use in network environments, in accordance with an embodiment;

FIG. 5A illustrates a screenshot of a user interface for submitting requests for application programming interfaces (APIs), in accordance with an embodiment;

FIG. 5B illustrates a screenshot of a user interface for inputting information on application programming interfaces (APIs) for requests, in accordance with an embodiment;

FIG. 5C illustrates a screenshot of a user interface for indicating results of validation and testing of application programming interfaces (APIs), in accordance with an embodiment;

FIG. 6 illustrates a block diagram of a system for aggregating metadata associated with application programming interfaces (APIs) from various data sources, in accordance with an embodiment;

FIG. 7 illustrates a block diagram of a graph for data elements in metadata associated with application programming interfaces (APIs) from various data sources, in accordance with an embodiment;

FIG. 8 illustrates a block diagram of a system for accessing application programming interface (API) catalogues used in network environments, in accordance with an embodiment;

FIG. 9A illustrates a screenshot of a user interface with a list of domains for application programming interface (API) catalogues, in accordance with an embodiment;

FIG. 9B illustrates a screenshot of a user interface to search application programming interface (API) catalogues, in accordance with an embodiment;

FIG. 9C illustrates a screenshot of a user interface including performance metrics for application programming interfaces (APIs), in accordance with an embodiment;

FIG. 10 illustrates a flow diagram of a method of integrating application programming interfaces (APIs) for use in networked environments, in accordance with an embodiment;

FIG. 11 illustrates a flow diagram of a method of selecting application programming interfaces (APIs) for use in network environments, in accordance with an embodiment; and

FIG. 12 illustrates a flow diagram of a method of cataloguing application programming interfaces (APIs) using metadata, in accordance with an embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Presented herein is a centralized service for an API management platform that may validate, test, integrate, and monitor APIs through their lifecycle by categorizing and aligning API specifications and identifying any redundancies and deprecations of APIs. The service may be a part of the network environment or separate from the network environment. The service may function as a single source of knowledge about APIs in the given network environment with the use of a robust API catalogue. By actively monitoring metadata and performance metrics of the APIs from the network, the service may update API records and update versioning. During the onboarding process, the service may also provide for codified controls and automated review. Through the lifecycle of a given API, the service may provide for automation and tooling for management, as well as observability into usage and analytics.

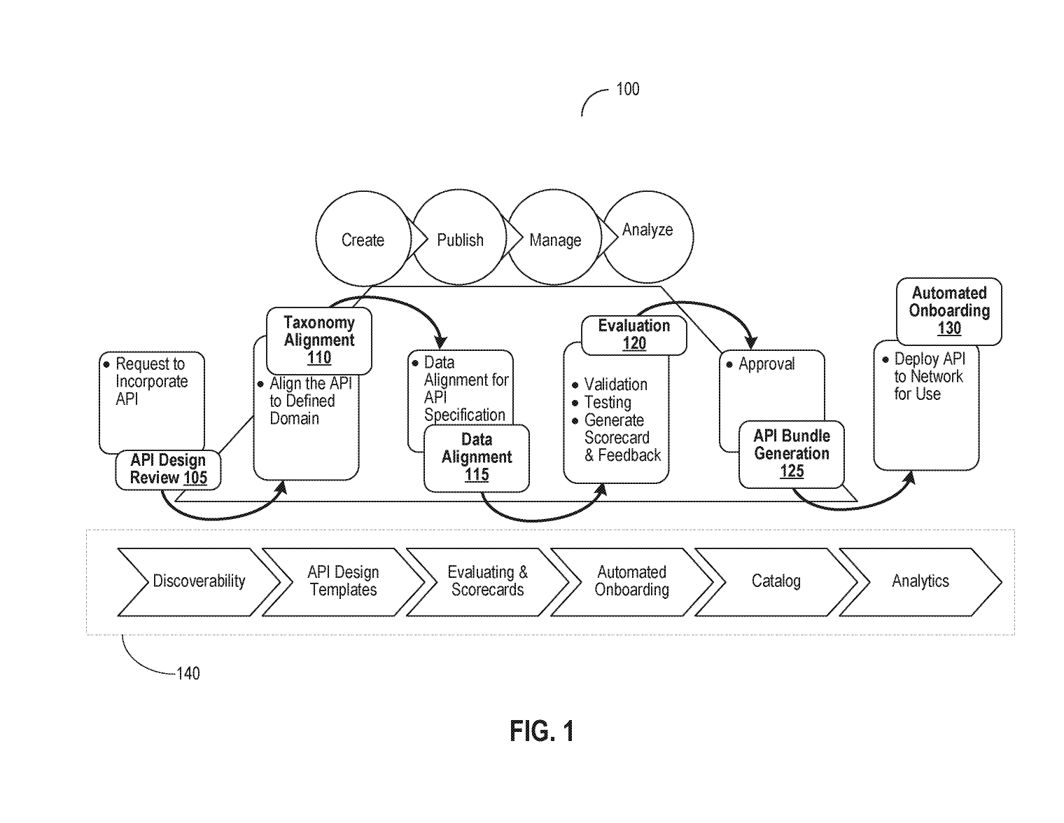

FIG. 1 illustrates a block diagram of a process 100 for automation of application programming interface (API) governance across API life cycles. The process 100 may be implemented or performed by a service associated with an API management platform. Under the process 100, at step 105, the service may conduct an API design review upon receiving a request to incorporate an API. The request may include a specification for the API generated in accordance with an API design template. At step 110, the service may align the API by standardizing the API specification using a generative model. The generative model may have been trained to generate a canonical representation of the API specification in a normalized manner. At step 115, the service may align the associated data in accordance with the domain defined for the API.

Continuing on, at step 120, the service may evaluate the API by performing validation and testing. Based on the validation and testing, the service may generate a score card of the API and feedback for the developer. In some embodiments, the service may use a generative model to generate a test schema defining test cases and execute test cases of the test schema to perform testing of the API. At step 125, if the API has been successfully validated and tested, the service may determine that the API is approved for use in a network environment. At step 130, the service may generate an API bundle to integrate the API into the environment. At step 135, the service may perform automated onboarding of the API onto the network for use. The process 100 may correspond to a sequence 140 for the life cycle of managing the API. The sequence 140 may include discoverability of the API specifications, using API design templates, with evaluating and scorecard generation, automated onboarding, cataloging, and monitoring analytics.

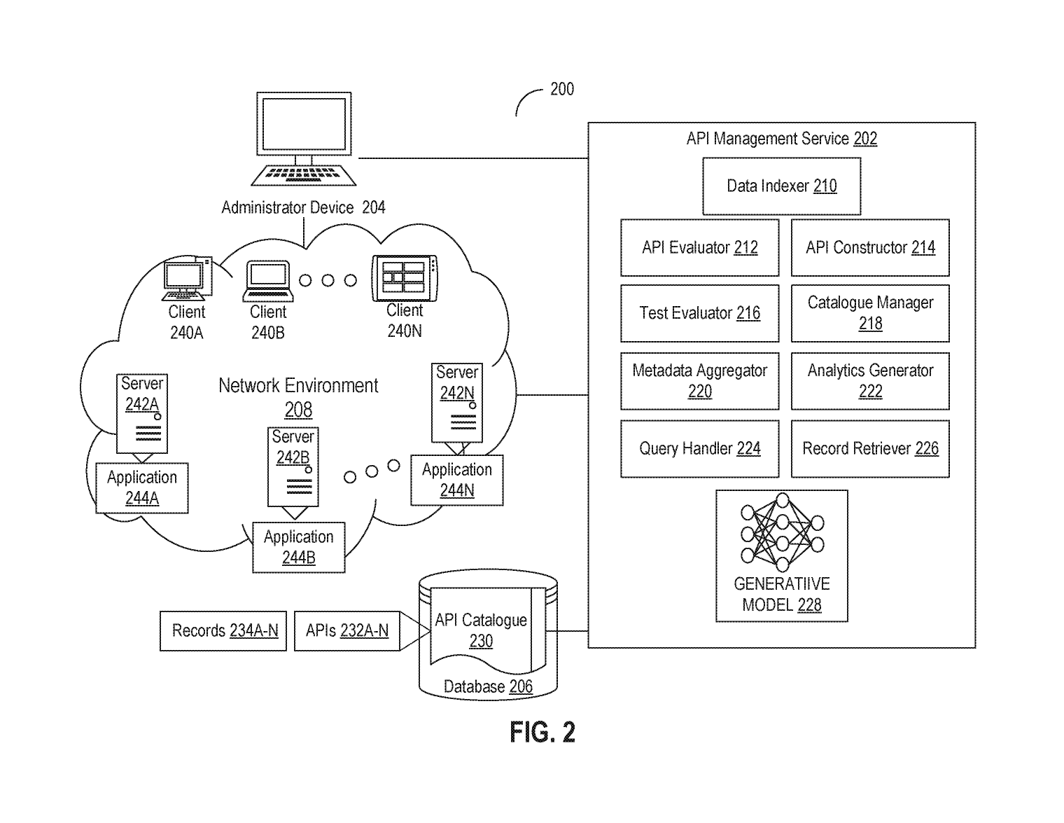

FIG. 2 illustrates a block diagram of a system 200 for managing application programming interfaces (APIs) in network environments. The system 200 may include at least one API management service 202, at least one administrator device 204, at least one database 206, and at least one network environment 208, among others. The API management service 202 may include at least one data indexer 210, at least one API evaluator 212, at least one API constructor 214, at least one test evaluator 216, at least one catalogue manager 218, at least one metadata aggregator 220, at least one analytics generator 222, at least one query handler 224, at least one record retriever 226, and at least one generative model 228, among others. The database 206 may store, maintain, or otherwise include at least one API catalogue 230, among others. The API catalogue 230 may identify a set of APIs 232A–N (hereinafter generally referred to as APIs 232) and a corresponding set of API records 234A–N (hereinafter generally referred to as API records 234). The network environment 208 may include one or more clients 240A–N (hereinafter generally referred to as clients 240) and one or more servers 242A–N (hereinafter generally referred to as servers 242). Each server 242 may host or include at least one application 244A–N (hereinafter generally referred to as applications 244), among others.

Embodiments may comprise additional or alternative components or omit certain components from those of FIG. 2 and still fall within the scope of this disclosure. For example, the API management service 202, the administrator device 204, and the database 206 may be part of the same device. Various hardware and software components of one or more public or private networks may interconnect the various components of the system 200. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

The API management service 202 may be any computing device including one or more processors coupled with memory and software and capable of performing the various processes and tasks described herein. The API management service 202 may be part of an API governance or management platform to control and administer APIs 232 used in network environments, such as the network environment 208. The API management service 202 may be in communication with the administrator device 204, the database 206, and the network environment 208, among others. Although shown as a single API management service 202, the API management service 202 may include any number of computing devices. The API management service 202 may interface with the administrator device 204 to exchange data associated with APIs to be integrated or onboarded in the network environment 208. The API management service 202 may communicate with the network environment 208 to exchange metadata and performance data about APIs in use among the clients 240, the servers 242, and the applications 244 of the network environment 208. The API management service 202 may control and manage the usage of APIs within the network environment 208.

The API management service 202 may include several subsystems to perform the operations described herein. In the API management service 202, the data indexer 210 may receive data for onboarding APIs for use under defined domains on the network environment 208. The API evaluator 212 may execute validation and performance testing on the APIs 232 in accordance with policies for domains using the generative model 228. The test evaluator 216 may carry out testing of the API specifications. The API constructor 214 may create data structures for the APIs 232 using the generative model 228. The catalogue manager 218 may maintain the API catalogue 230 on the database 206 of API specifications and related data for APIs 232 approved for use in the network environment 208 using the generative model 228. The metadata aggregator 220 may retrieve metadata and related data associated with the API from various sources, including the administrator device 204 and the network environment 208. The analytics generator 222 may carry out analytics on the metadata associated with APIs. The query handler 224 may receive queries for APIs 232 on the API catalogue 230. The record retriever 226 may search for APIs corresponding to the queries.

The generative model 228 may include any AI algorithm or machine learning (ML) model to generate output with statistical characteristics consistent with training corpuses that the model was trained on, when given the input. The generative model 228 may include, for example, a transformer-based deep neural network (e.g., a large language model (LLM) such as a generative pre-trained transformer (GPT) or a bidirectional encoder representation from transformer (BERT)), a variational autoencoder (VAE), or a generative adversarial network (GAN), among others. In general, the generative model 228 may include an input, outputs, and a set of weights arranged across a set of layers to relate the input and the output. The input may include a prompt (e.g., alphanumeric characters or strings) or tokens. The set of weights may be arranged or configured in accordance with the ML architecture used for the generative model 228.

The administrator device 204 may be any computing device operable by a user to interface with the API management service 202. For example, the administrator device 204 may be operated or used by an entity associated with a software developer to design and add APIs 232 for use in the network environment 208. In some cases, the entity associated with the administrator device 204 may be an administrator of the network environment 208. The administrator device 204 may include any number of computing devices and may be in communication with the API management service 202 and the network environment 208, among others.

The database 206 may store and maintain various data associated with the APIs, such as the API catalogue 230, or any other data from the API management service 202, the administrator device 204, and the network environment 208, among others. The API catalogue 230 may include or identify a set of API records 234 for corresponding APIs 232 approved for use in the network environment 208. Each API 232 may define, identify, or otherwise include a set of protocols or definitions to permit communications and interfacing among the applications 244 in the network environment 208. Each record 234 may identify or include information related to the respective API 232, such as the metadata and performance analytics, among others. The database 206 may also include a database management system (DBMS) to arrange and organize the data maintained thereon. The data stored and maintained on the database 206 may be in accordance with at least one data scheme. The database 206 may be in communication with the API management service 202, the administrator device 204, and the network environment 208, among others.

The network environment 208 may include or correspond to a defined network in which the set of clients 240 and the servers 242 may be in communication with one another. For example, the network environment 208 may correspond to an enterprise network, with clients 240 spread across multiple locales and servers 242 residing in data centers or branch offices, among others. To facilitate such communications, the network for the network environment 208 may include one or more of: Local Area Network (LAN), Wireless Local Area Network (WLAN), Metropolitan Area Network (MAN), Wide Area Network (WAN), software-defined networking (SDN), virtual private networks (VPNs), and the Internet, among others. The communication over the network may be performed in accordance with various communication protocols, such as Transmission Control Protocol and Internet Protocol (TCP/IP), User Datagram Protocol (UDP), and IEEE communication protocols.

In some embodiments, the network environment 208 may include a cloud-based service, e.g., Software as a Service (SaaS), Platform as a Service (PaaS), and Infrastructure as a Service (IaaS). IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, e.g., the operating system, middleware, or runtime resources. SaaS providers may offer the resources that PaaS provides, including storage, networking, servers, virtualization, operating system, middleware, or runtime resources. In some embodiments, SaaS providers may offer additional resources including, e.g., data and application resources.

Each client 240 may be any computing device including one or more processors coupled with memory and software and capable of performing the various processes and tasks described herein. Each client 240 may be associated with an end user entity within the network environment 208. For example, the client 240 may be a virtual machine associated with a member of an enterprise network. The client 240 may be in communication with the servers 242, the network environment 208, the administrator device 204, and the API management service 202, among others.

Each server 242 may be any computing device including one or more processors coupled with memory and software and capable of performing the various processes and tasks described herein. The server 242 may host or include resources for at least one of the applications 244 to be accessed by one of the clients 240. The server 242 may be associated with an entity maintaining the respective application 244. For instance, the server 242 may be maintained by the same entity that developed the application 244. The server 242 may be in communication with the clients 240, the network environment 208, the administrator device 204, and the API management service 202, among others.

Each application 244 may be a cloud-based application (e.g., a Software as a Service (SaaS)), a web application, a microservice, or a service, among others, accessed by end-user customer devices that are communicatively coupled with the network environment 208. For example, the application 244 may be an online banking application, a brokerage account application, a word processor, a spreadsheet program, a multimedia player, a video game, or a software development kit, among others. The applications 244 may interface or communicate with one another via one or more APIs 232. For instance, one application 244 may access functionality and data of another application 244 via at least one API 232 used in the network environment 208.

The API management service 202 (or the platform) may reside within or outside the network environment 208 for which API management service 202 is managing APIs 232. In some embodiments, the network environment 208 may include the API management service 202. For example, the API management service 202 may reside within the same network as the clients 240 and servers 242, manage and administer the APIs from within the network environment 208, and interface with the administrator device 204 outside the network environment 208. In some embodiments, the network environment 208 may include the administrator device 204. For instance, the administrator device 204 may interface with the API management service 202 outside the network environment 208 to manage and administer API usage within the network environment 208.

In some embodiments, the network environment 208 may include the API management service 202 and the administrator device 204. For example, both the API management service 202 and the administrator device 204 may be part of the network environment 208 to manage and administer APIs used internally within the network environment 208. In some embodiments, the network environment 208 may be separate from the API management service 202 and the administrator device 204. For instance, the administrator of the network environment 208 may interface with the API management service 202 to add and provide specifications for the APIs 232 for use in network environments, such as the network environment 208. The API management service 202, in turn, may monitor data within the network environment 208 from outside.

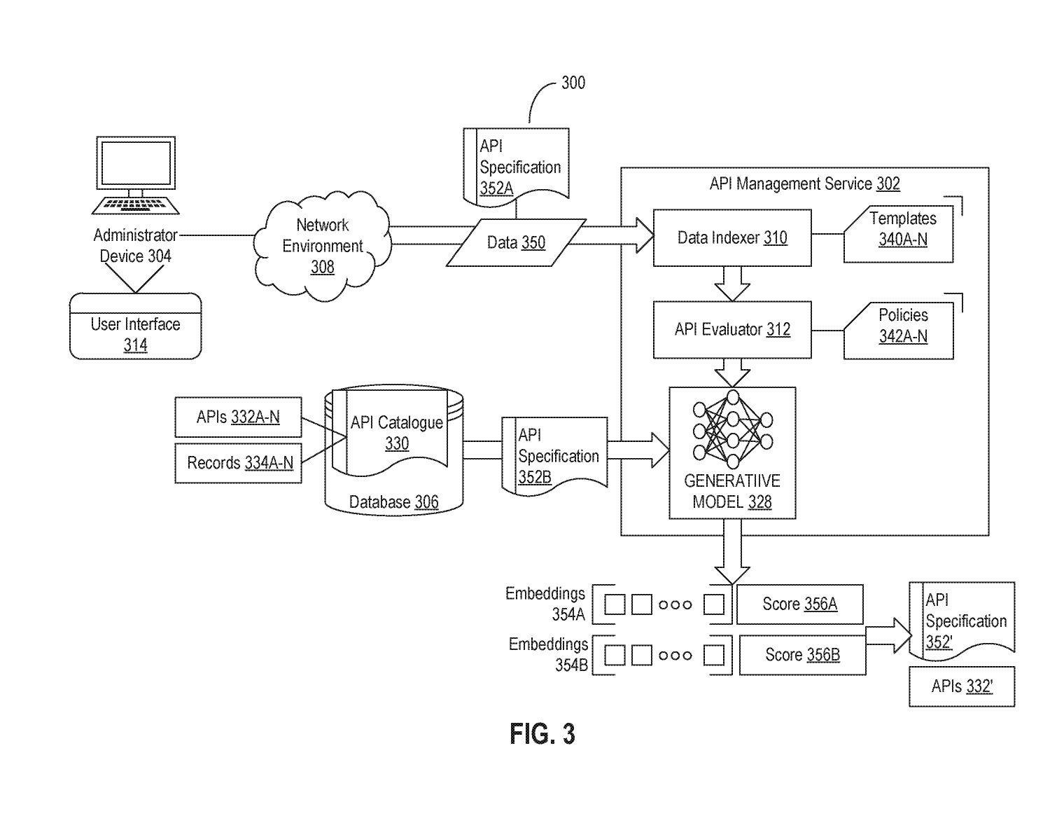

FIG. 3 illustrates a block diagram of a system 300 for detecting application programming interfaces (APIs) for use in network environments. The system 300 may include at least one API management service 302, at least one administrator device 304, and at least one database 306, among others. The API management service 302 may include at least one data indexer 310, at least one API evaluator 312, and at least one generative model 328, among others. The administrator device 304 may provide at least one user interface 314, among others. The database 306 may store or include the API catalogue 330, among others. The API catalogue 330 may include or identify a set of APIs 332A–N (hereinafter generally referred to as APIs 332) and a corresponding set of records 334A–N (hereinafter generally referred to as records 334).

Embodiments may comprise additional or alternative components or omit certain components from those of FIG. 3 and still fall within the scope of this disclosure. Various hardware and software components of one or more public or private networks may interconnect the various components of the system 300. Each component in system 300 (such as the API management service 302, the administrator device 304, the database 306, and the network environment 308) may be any computing device comprising one or more processors coupled with memory and software and capable of performing the various processes and tasks described herein.

The data indexer 310 on the API management service 302 may identify, obtain, or otherwise retrieve data 350 from the network environment 308. The data 350 may include any information (e.g., in structured or unstructured form) associated with at least one API 332A for a set of functions available for invocation by one or more applications in the network environment 308. In some embodiments, the data 350 may include at least a portion of an API specification 352A for the API 332A. For example, the API specification 352A may be created via the user interface 314 on the administrator device 304 by a system administrator submitting an API 332A for use in the network environment 308. The API specification 352A may be structured (e.g., with field-value pairs) or unstructured (e.g., free text, in a non-standard form). In some embodiments, the data 350 may include at least one transaction log identifying invocations of the set of functions of the API 332A. For instance, the data indexer 310 may fetch or receive the transaction log from one of the servers hosting an application that uses the API 332A to interface with other applications and computing devices. In some embodiments, the data 350 may include at least one domain policy. The policy may define or identify a set of conditions to be applied to the API 332A for a particular domain. The set of conditions may specify constraints on the use of the functions and communications of data via the API 332A. The domain may include, for example, an application type, a geographic region, or a defined portion of the network environment 308.

With retrieval, the data indexer 310 may process or parse the data 350 to extract or identify the API specification 352, the transaction log, or the domain policy associated with the API 332A. As the data 350 is retrieved from the network environment 308, the data indexer 310 may determine or identify the data 350 as associated with a given API 332A from parsing the data 350. From parsing, the data indexer 310 may extract or identify at least one API identifier (e.g., API name or version) in the data 350. When one or more portions of the data 350 have the same API identifier, the data indexer 310 may identify the one or more portions of the data 350 as associated with the API 332A. The portions of data may be used to construct the API specification 352A in full. When one or more portions of the data 350 have different API identifiers, the data indexer 310 may identify the one or more portions of the data 350 as associated with multiple respective APIs 332.

In some embodiments, the data indexer 310 may receive the data 350, including the API specification 352A generated using at least one of a set of templates 340A–N (hereinafter generally referred to as templates 340). The data indexer 310 may store or maintain the templates 340. The set of templates 340 may be stored and maintained (e.g., as one or more data structures or files) on the database 306. Each template 340 may specify, define, or otherwise identify a format for the information to be included for defining at least one API 332. The format may define or specify a standardized structure for the arrangement of the information for the API 332. Each template 340 may be associated with one or more respective domains. The domains may correspond to or otherwise be associated with a type of function or application associated with the API 332. The domains may, for example, include various functions of a banking application, such as account management, customer data management, risk management, and messaging, among others. The templates 340 may be defined or configured by an administrator or entity associated with the API management service 302.

The template 340 may specify the format for information for the API 332 itself, such as an endpoint (e.g., a uniform resource identifier (URI) defining an entry point for interacting with the API 332), a method (e.g., an action or operation performed via the API 332), a response format, and error handling, among others. The template 340 may also define the format for metadata associated with the API 332, such as a domain identifier, an API identifier, an API version, an API life cycle stage (e.g., review, testing, validation, onboarding, integrated, or deprecated), a gateway identifier (e.g., the server hosting the associated application), a product identifier (e.g., the associated applications), an API version, an owner identifier, an API type, a data classification (e.g., of the data exchanged through the API 332), an authorization level, a geographical region, or organizations, among others. The template 340 may specify the format for the documentation in accordance with a respective domain. For example, the template 340 may specify information to be included pertinent to the type of function or application associated with the API 332, such as security measures to handle communication of sensitive information.

The data indexer 310 may send, transmit, or otherwise provide the user interface 314 to the administrator device 304. In some embodiments, the data indexer 310 may transmit or send an instruction to display, render, or otherwise present the user interface 314 via the administrator device 304. The user interface 314 may be a graphical user interface of an application (e.g., web application) supported by the API management service 302. The user interface 314 may include one or more fields (e.g., user interface elements) for defining an API 332. The fields may include or identify, for example: information for the API 332 itself (e.g., an endpoint, a method, a response format, and error handling); metadata for the API 332 (e.g., a domain identifier, an API identifier, an API version, a life cycle stage, a gateway identifier, a product identifier, an owner identifier, an API type, a data classification, an authorization level, a geographical region, or organizations); and documentation for the API 332, among others. In some embodiments, the fields of the user interface 314 may be defined in accordance with one of the templates 340. For example, the administrator device 304 may have requested for the user interface 314 to define the API 332 for a particular domain. The data indexer 310 in turn may provide the instructions for presenting the user interface 314 with fields to define the information in accordance with the template 340 of the domain.

The administrator device 304 may retrieve, obtain, or otherwise receive the user interface 314 from the API management service 302. For instance, the administrator device 304 may receive the instruction for presentation of the user interface 314 from the API management service 302. With the receipt, the administrator device 304 may present the user interface 314 via a display and may accept user inputs on the user interface 314. Using the inputs on the user interface 314, the administrator device 304 may create, write, or otherwise generate at least one request (e.g., as part of the data 350). The request may identify or include at least one API specification 352 for the API 332. The API specification 352 may include the information inputted via the fields of the user interface 314. In some embodiments, the administrator device 304 may generate the API specification 352 in an initial format (e.g., different from the templates 340). In some embodiments, the administrator device 304 may generate the API specification 352 in accordance with the template 340 corresponding to the identified domain. With the generation, the administrator device 304 may provide, transmit, or otherwise send the request (e.g., as part of the data 350) including the API specification 352 to the API management service 302.

The data indexer 310 retrieves, identifies, or otherwise receives the request from the administrator device 304. With receipt, the data indexer 310 may process or parse the request to extract or identify the API specification 352. The data indexer 310 may extract or identify the information from the API specification 352. From the API specification 352, the data indexer 310 may extract or identify information for the API 332 itself (e.g., an endpoint, a method, a response format, and error handling); metadata for the API 332 (e.g., a domain identifier, an API identifier, an API version, a life cycle stage, a gateway identifier, a product identifier, an owner identifier, an API type, a data classification, an authorization level, a geographical region, or organizations); and documentation for the API 332. In addition, from the information of the API specification 352, the data indexer 310 may also determine or identify at least one domain associated with the API 332 defined by the specification 352.

With the identification of the domain, the data indexer 310 may identify or select the template 340 corresponding to the domain. The data indexer 310 may change, alter, or otherwise modify the API specification 352 in accordance with the template 340. In some embodiments, the data indexer 310 may convert or translate the information included in the API specification 352 into the format defined by the template 340. For example, the data indexer 310 may perform alignment by inserting the information from the API specification 352 into the structure of the standardized format specified by the template 340 for the domain. The data indexer 310 may store and maintain the standardized API specification 352.

Using the data 350 retrieved from the network environment 308, the API evaluator 312 may apply or execute the generative model 328. The generative model 328 may have been trained or fine-tuned to generate any number of outputs related to API specifications. The generative model 328 may have been trained or fine-tuned using a corpus. In some embodiments, the corpus may include API specifications in non-normalized form (e.g., unstructured and free text) and normalized form (e.g., in expected, standard, or canonical form). A portion of the corpus including the API specification in the non-normalized form may be identified as a source set, and another portion of the corpus including the API specification in the normalized form may be identified as a destination set. The generative model 328 may be provided (e.g., by the API management service 302) with the source set as input and may generate an output. A distribution of the tokens in the output from the generative model 328 may be compared with a distribution of tokens in the expected output as derived from the destination set. Based on the comparison, a loss metric (e.g., cross-entry loss, a divergence loss, or mean average loss) may be calculated, and the loss metric may be used to update the one or more weights in the generative model 328. To execute the generative model 328, the API evaluator 312 may generate and provide a prompt directing the generative model 328 to generate the API specification 352A in a normalized form (e.g., canonical form).

Based on the execution of the generative model 328, the API evaluator 312 may produce, extract, or otherwise generate a set of embeddings 354A for the API specification 352A. The API specification 352A may at least partially define the set of functions available via the API 332A for invocation by the one or more applications in the network environment 308. The set of embeddings 354A may include an encoded lower-dimensional representation of the content (e.g., tokens corresponding to words or phrases) of the API specification 352A. In executing the generative model 328, the API evaluator 312 may generate or create at least one output including a summarization of the API specification 352A. The summary may be a concise description of the functionalities available through the API 332A. For example, the summary of the output may include an identification of one or more functions available for invocation via the API 332A as defined by the API specification 352A. Based on executing the generative model 328 using the summary, the API evaluator 312 may generate the set of embeddings 354A for the API specification 352A.

The API evaluator 312 may identify or determine an occurrence or a lack of redundancy (also referred to herein as a duplicate or an equivalence) between the API specification 352A and at least one other API specification 352B. The API specification 352B may be associated with another API 332B in use in the network environment 308. To determine, the API evaluator 312 may select or identify a set of embeddings 354B corresponding to the API specification 352B for the API 332B. The API specification 352B may identify or define a set of functions available for invocation to the one or more applications in the network environment 308 via the API 332B. The API specification 352B and the set of embeddings 354B derived from the API specification 352B may be stored and maintained on the database 306. The set of embeddings 354B may be generated in a similar manner as the set of embeddings 354A. In some embodiments, with the identification of API specification 352B from the database 306, the API evaluator 312 may execute the generative model 328 using the API specification 352B (or the summary derived from the API specification 352B) to yield the set of embeddings 354B.

With the identification, the API evaluator 312 may compare the set of embeddings 354A for the API specification 352A with the set of embeddings 354B for the API specification 352B. To compare, the API evaluator 312 may calculate or determine a distance between the set of embeddings 354A for the API specification 352A and the set of embeddings 354B for the API specification 352B. The distance may indicate a degree of difference in values between the set of embeddings 354A and the set of embeddings 354B. With the determination, the API evaluator 312 may check the distance against a threshold. The threshold may define a value for the distance at which to determine whether the API specifications are redundant. If the distance satisfies (e.g., less than or equal to) the threshold, the API evaluator 312 may determine the occurrence of the redundancy between the API specification 352A and the API specification 352B. Conversely, if the distance does not satisfy (e.g., greater than) the threshold, the API evaluator 312 may determine the lack of the redundancy between the API specification 352A and the API specification 352B.

In some embodiments, the API evaluator 312 may apply or execute a clustering model using the set of embeddings 354A with the set of embeddings 354B. The clustering model may include or define at least one feature space upon which the sets of embeddings can be assigned as data points (e.g., with dimensions equivalent to the number of embeddings in each set). The clustering model may include a set of clusters in the feature space. The clustering model may have trained and updated using sets of embeddings for API specifications used in the network environment 308. Each cluster may include a subset of the sets of embeddings corresponding to a respective subset of the API specifications used in the network environment 308. From executing the clustering model, the API evaluator 312 may identify or determine a first cluster assignment corresponding to one of the clusters for the set of embeddings 354A and a second cluster assignment corresponding to one of the clusters for corresponding to the set of embeddings 354 within the feature space. Based on the cluster assignments, the API evaluator 312 may determine the occurrence or the lack of the redundancy. When the cluster assignments are to the same cluster in the clustering model, the API evaluator 312 may determine the API evaluator 312 to determine the occurrence of the redundancy between the API specification 352A and the API specification 352B. On the other hand, when the cluster assignments are to different clusters, the API evaluator 312 may determine the lack of redundancy between the API specification 352A and the API specification 352B.

When the occurrence of the redundancy is determined, the API evaluator 312 may identify or select an API 332’ from the API 332A for API specification 352A and the API 332B for the API specification 352B. The selection may be based on a comparison of the first set of functions of the API 332A and the second set of functions of the API 332B. To select, the API evaluator 312 may execute the generative model 328 using the API specification 352A for the API 332A to calculate or determine at least one score 356A. The score 356A may indicate a degree of capability (e.g., number of paths, methods, or schemas) of the set of functions of the API 332A. The evaluator 312 may execute the generative model 328 using the API specification 352B for the API 332B to calculate or determine at least one score 356B. The score 356B may indicate a degree of capability (e.g., number of paths, methods, or schemas) of the set of functions of the API 332B.

Based on the scores 356A and 356B, the API evaluator 312 may select the API 332’ from one of the APIs 332A and 332B for integration, deployment, or use in the network environment 308. For example, the API evaluator 312 may select the API 332’ corresponding to the API 332A or 332B with the highest score 356A or 356B. In addition, the API evaluator 312 may select the API specification 352A or 352B corresponding to the selected API 332’ as the selected API specification 352’. In some embodiments, the API evaluator 312 may select the APIs based on other factors as detailed herein. When the absence of the redundancy is determined, the API evaluator 312 may select both the API 332A for API specification 352A and the API 332B for the API specification 352B for use in the network environment 308. In addition, the API evaluator 312 may select both the API specification 352A and the API specification 352B.

In some embodiments, the API evaluator 312 may select the API 332’ in accordance with a set of policies 342A–N (hereinafter generally referred to as policies 342). In some embodiments, the API evaluator 312 may store and maintain a set of policies 342. The set of policies 342 may be stored and maintained (e.g., as one or more data structures or files) on the database 306. In some embodiments, the policies 342 may be received with the data 350 for the API 332 from the network environment 308. Each policy 342 may specify, identify, or otherwise define a set of rules or criteria that the API 332 is to satisfy in order to be approved for use in the network environment. Each policy 342 may be associated with at least one respective domain. For instance, the policy 342 for APIs to be used in banking customer applications may differ from the policy 342 for APIs to be used in data encryption applications. In some embodiments, the domain may correspond to a region (or portion of computing devices) within the network environment 308.

Each policy 342 may include a set of rules for validation and a set of rules for testing, among others. The rules for validation may identify, for example, data criteria (e.g., expected format of data exchanged through API 332), documentation criteria (e.g., checking for inclusion of information), and compliance criteria (e.g., handling and encryption of data), among others. The rules for testing may identify, for instance, criteria for functionality (e.g., proper operations) and performance metrics (e.g., response times, throughput, and system utilization), among others. The rules for validation and testing may be specific for the domain. For example, the policy 342 may specify that data communicated for APIs related to security applications are to be of a certain encryption level. In some embodiments, the policy 342 may specify or define an applicability of the API specification 352 (and the API 332) to a particular region for the network environment 308. The region may correspond to a geographic region (e.g., a municipality, a province, a state, a country, or a set of countries in a given area), an organization (e.g., an enterprise, a data center, or a branch office), or any subset of computing devices within the network environment 308.

The API evaluator 312 selects or identifies at least one policy 342 from the set of policies 342 based on the domain associated with the API 332. In some embodiments, the API evaluator 312 may select the policy 342 based on the domain identified in the template 340 with which the API specification 352 is defined. With the identification of the policy 342, the API evaluator 312 may identify or determine whether the API 332 is validated. The validation may be to permit, allow, or otherwise approve the API 332 for use in the network environment. In some embodiments, the API evaluator 312 may perform the validation in response to a separate request from the administrator device 304.

To validate, the API evaluator 312 may check the API 332 (or the API specification 352) using the set of rules defined by the policy 342. The set of rules may include the rules for validation in the policy 342. For each rule of the policy 342, the API evaluator 312 may determine whether the API 332 satisfies the criteria defined by the rule. If the API 332 satisfies the criteria, the API evaluator 312 may determine that the API 332 is in compliance with the rule. Conversely, if the API 332 does not satisfy the criteria, the API evaluator 312 may determine that the API 332 is not in compliance with the rule. When the API 332 is in compliance with all the rules, the API evaluator 312 may determine that the API 332 is validated. Otherwise, when the API 332 is not in compliance with all the rules, the API evaluator 312 may determine that the API 332 is not validated. In some embodiments, the API evaluator 312 may identify a subset of rules that the API 332 is not in compliance with (e.g., not validated) and a remaining subset of rules that the API 332 is in compliance with (e.g., validated).

In some embodiments, the API evaluator 312 may identify or determine whether the API 332 satisfies a functionality (or performance) criteria using the set of rules defined by the policy 342. The set of rules may include the rules for testing as defined by the policy 342. For each rule of the policy 342, the API evaluator 312 may determine whether the API 332 satisfies the criteria defined by the rule. If the API 332 satisfies the criteria, the API evaluator 312 may determine that the API 332 is in compliance with the rule. Conversely, if the API 332 does not satisfy the criteria, the API evaluator 312 may determine that the API 332 is not in compliance with the rule. When the API 332 is in compliance with all the rules, the API evaluator 312 may determine that the API 332 satisfies the functionality criterion. Otherwise, when the API 332 is not in compliance with all the rules, the API evaluator 312 may determine that the API 332 does not satisfy the functionality criterion. In some embodiments, the API evaluator 312 may identify a subset of rules that the API 332 is not in compliance with and identify a remaining subset of rules that the API 332 is in compliance with.

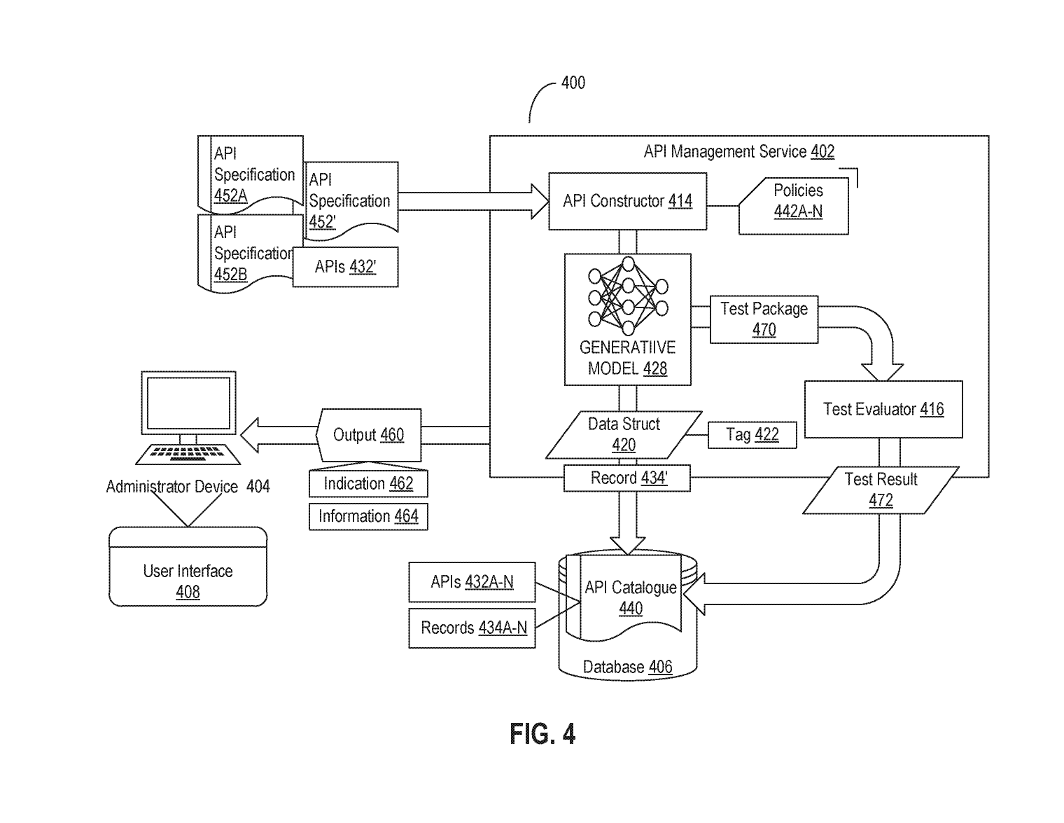

FIG. 4 illustrates a block diagram of a system 400 for integrating application programming interfaces (APIs) for use in network environments. The system 400 may include at least one API management service 402, at least one administrator device 404, and at least one database 406, among others. The API management service 402 may include at least one API constructor 414, at least one test evaluator 416, and at least one generative model 428, among others. The administrator device 404 may provide at least one user interface 408, among others. The database 406 may store or include the API catalogue 440, among others. The API catalogue 440 may include or identify a set of APIs 432A–N (hereinafter generally referred to as APIs 432) and a corresponding set of records 434A–N (hereinafter generally referred to as records 434).

Embodiments may comprise additional or alternative components or omit certain components from those of FIG. 4 and still fall within the scope of this disclosure. Various hardware and software components of one or more public or private networks may interconnect the various components of the system 400. Each component in system 400 (such as the API management service 402, the administrator device 404, and the database 406) may be any computing device comprising one or more processors coupled with memory and software, and capable of performing the various processes and tasks described herein.

The API constructor 414 executing on the API management service 402 may write, create, or otherwise configure at least one record 434’. The record 434’ may indicate or identify at least one selected API 432’ as permitted for use by one or more applications in a network environment. The API 432’ may be defined by the API specification 452’ selected from API specifications 452A and 452B. The API 432’ may be selected from at least one of APIs 452A or 452B. When the occurrence of redundancy is determined between the APIs 452A and 452B, the API constructor 414 may configure the record 434’ to identify the API 432’ selected from APIs 452A or 452B as permitted for use in the network environment. Conversely, when the lack of redundancy is determined between the APIs 452A and 452B, the API constructor 414 may configure the record 434’ to identify both APIs 452A and 452B as permitted for use in the network environment. With the configuration, the API constructor 414 may store the record 434’ in the API catalogue 440 on the database 406. In some embodiments, the API constructor 414 may store and maintain an association between the API 432’ (or the API specification 452) and the record 434’ on the database 406. The API constructor 414 may add, insert, or otherwise include the association of the API 432’ (or the API specification 452 standardized according to the template) as the record 434’ in the API catalogue 430.

In configuring the record 434’, the API constructor 414 may apply or execute the generative model 428 using data associated with the API specification 452’. The data retrieved from the network environment may contain or include at least a portion of the definitions of the functions for the API specification 452’. The generative model 428 may be used to infer or create a fuller definition of the functions for the API specification 452’ that are available for invocation via the API 432’. The generative model 428 may have been trained or fine-tuned using a corpus. In some embodiments, the corpus may include API specifications in non-normalized form (e.g., unstructured and free text) and normalized form (e.g., in expected, standard or canonical form). A portion of the corpus including the API specification in the non-normalized form may be identified as a source set, and another portion of the corpus including the API specification in the normalized form may be identified as a destination set. The generative model 428 may be provided (e.g., by the API management service 402) with the source set as input and may generate an output. A distribution of the tokens in the output from the generative model 428 may be compared with a distribution of tokens in the expected output as derived from the destination set. Based on the comparison, a loss metric (e.g., cross-entry loss, a divergence loss, or mean average loss) may be calculated and the loss metric may be used to update the one or more weights in the generative model 428. To execute the generative model 428, the API constructor 414 may generate and provide a prompt directing the generative model 428 to generate the API specification 352’ corresponding to the selected API 432’ in a normalized form (e.g., canonical form).

Based on executing the generative model 428, the API constructor 414 may generate or create at least one data structure 420 for the API specification 452’. The data structure 420 may include information about the API specification 452’ (e.g., API metadata, endpoints, methods, operations, parameters for functions, and response details) in a structured, standardized, canonical form. The data structure 420 may include a set of fields and a corresponding set of values in accordance with the canonical form. The set of fields and the corresponding set of values of the data structure 420 may define the set of functions available for invocation to the one or more applications in the network environment via the API 432’. In some embodiments, in applying the generative model 428, the API constructor 414 may determine or identify at least one field corresponding to a missing value in the set of values in the data structure 420. For each field with a missing value, the API constructor 414 may apply the generative model 428 using the data associated with the API 432’ to generate a new value to include in the field. When multiple APIs 432’ are selected (e.g., both APIs 452A and 452B), the API constructor 414 may create a respective data structure 420 for each of the selected APIs 432’. With the creation of the data structure 420, the API constructor 414 may store the data structure 420 with the record 434’ on the database 406.

In some embodiments, the API constructor 414 may determine or identify at least one policy 442 from a set of policies 442A–N (hereinafter generally referred to as policies 442). The set of policies 442 may be stored and maintained (e.g., as one or more data structures or files) on the database 406. In some embodiments, the policies 442 may be received with the data for the API 432’ from the network environment. Each policy 342 may specify, identify, or otherwise define a set of rules or criteria that the API 332 is to satisfy in order to be approved for use in the network environment. Each policy 342 may be associated with at least one respective domain. In some embodiments, the policy 342 may specify or define an applicability of the API specification 352 (and the API 332) to a particular region for the network environment 308. The region may correspond to a geographic region (e.g., a municipality, a province, a state, a country, or a set of countries in a given area), an organization (e.g., an enterprise, a data center, or a branch office), or any subset of computing devices within the network environment 308.

With the identification, the policy 442, the API constructor 414 may create or generate at least one tag 422 to include with the data structure 420 for the API specification 452’. The tag 422 may define the applicability of the API 432’ (or the API specification 452’) to a certain domain or region as identified by the at least one policy 442. For instance, the tag 422 may specify that the policy 442 is a control or constraint invocation of functions available via the API 432’ and defined by the API specification 452’ in a particular domain or region. The policy 442 may restrict movement data communicated in invoking the function from a particular country, organization, or subset of computing devices in the network environment. When a client device calls the function of the API 432’, the API management service 402 (or the server hosting the application for the API 432’ in the network environment) may check against the policy 442 when the tag 422 is included with the data structure 420 for the API 432’. In some embodiments, the API constructor 414 may execute the generative model 428 using the data structure 420 and the tag 422 to update one or more values within the data structure 420. For instance, certain values in the data structure 420 associated with domain or region may be modified or updated, based on the inclusion of the tag 422 as determined by the generative model 428. With the creation of the tag 422, the API constructor 414 may store the data structure 420 with the tag 422 along with the record 434’ on the database 406. The record 434’ may identify or indicate that the API 432’ is permitted for use in the region or domain in accordance with the policy 442 as identified in the tag 422.

The test evaluator 416 executing on the API management service 402 may apply or execute the generative model 428 using the API specification 452’ (or the data structure 420 or record 434’). The generative model 428 may have been trained or fine-tuned to generate any number of outputs related to test packages from API specifications. The generative model 428 may have been trained or fine-tuned using a corpus. In some embodiments, the corpus may include API specifications and test packages, with each package including test cases and test data. A portion of the corpus including the API specification may be identified as a source set, and another portion of the corpus including the test package may be identified as a destination set. The generative model 428 may be provided (e.g., by the API management service 402) with the source set as input and may generate an output. A distribution of the tokens in the output from the generative model 428 may be compared with a distribution of tokens in the expected output as derived from the destination set. Based on the comparison, a loss metric (e.g., cross-entry loss, a divergence loss, or mean average loss) may be calculated, and the loss metric may be used to update the one or more weights in the generative model 428. To execute the generative model 428, the API evaluator 412 may generate and provide a prompt directing the generative model 428 to generate a test package to evaluate the API 432’.

Based on executing the generative model 428, the test evaluator 416 may create or generate at least one test package 470. The test package 470 may identify or include at least one test schema and at least one test dataset. The test package 470 may be used to validate the functions available via the API 432’ and may specify the expected behavior. The test schema may define one or more test cases for at least one of the functions of the API 432’. Each test case may correspond to an executable scenario to evaluate a given function of the API 432’ and may identify inputs for the function and expected outputs from the function. The test dataset may include synthetic data to evaluate the function of the API 432’ against a corresponding test case in the test schema. The test dataset may prevent exposure to real production data and may provide a range of expected values for input. The test package 470 may be stored and maintained as one or more data files (e.g., JavaScript Object Notation (JSON), Extensible Markup Language (XML), or YAML) on the database 406.

With the generation of the test package 470, the test evaluator 416 may run or execute the at least one test case in the test schema of the test package 470 to evaluate the API 432’. For the test package 470, the test evaluator 416 may instantiate a sandbox environment in which to run the test cases. For each test case, the test evaluator 416 may call or invoke the identified function using the test data. In invoking, the test evaluator 416 may pass at least a portion of the test data as input parameters into the function of the API 432’ and may identify an output from the function based on the input parameters. The test evaluator 416 may determine whether the output from the function corresponds to the expected output as identified in the test case.

From invoking the functions of the test cases, the test evaluator 416 may create or generate a test result 472 for the API 432’. The test result 472 may indicate whether the output from the function corresponds to the expected output as identified in the test case. When all the outputs from the tested functions correspond to the expected outputs as identified in the test cases, the test result 472 may indicate that the API 432’ has passed the test evaluation. Conversely, when at least one of the outputs from the tested functions does not correspond to the expected output as identified in the associated test case, the test result 472 may indicate that the API 432’ has not passed the test evaluation. With the generation of the test result 472, the test evaluator 416 may store and maintain an association between the test result 472 and the record 434’ for the API 432’.

In some embodiments, the API constructor 414 may produce, create, or otherwise generate at least one indication 462 based on determining whether the API 432’ is validated (in accordance with the policy 442 or the test package 470). When the API 432’ is determined to be validated (e.g., in conformance with the policy 442 or passes the test cases), the API constructor 414 may generate the indication 462 to approve the API 432’ for use in the network environment. When the API 432’ is determined to be not validated (e.g., not in conformance with the policy 442 or does not pass the test cases), the API constructor 414 may generate the indication 462 to disapprove the API 432’ for use in the network environment. In some embodiments, the API constructor 414 may generate the indication 462 based on determining whether the API 432’ is validated and whether the API 432’ satisfies the functionality criterion. When the API 432’ is determined to be validated and satisfy the functionality criterion, the API constructor 414 may generate the indication 462 to approve the API 432’ for use in the network environment. When the API 432’ is determined to be not validated or to not satisfy the functionality criterion, the API constructor 414 may generate the indication 462 to disapprove the API 432’ for use in the network environment.

The API constructor 414 may perform integration of the API 432’ for use by the applications in the network environment. The integration may be performed when the API 432’ is selected and validated (e.g., using the policy 442 or the test package 470). The integration may include permitting applications to invoke functions defined by the API 432’ and developers associated with the network environment to access documentation related to the API 432’ through the database 406. The API constructor 414 may also generate an API bundle using the API specification 452’ to make the API 432’ available for use in the network environment. Conversely, when the indication 462 is to disapprove the API 432’ for use in the network environment, the API constructor 414 may store the association to restrict the use of the API 432’ in the network environment. By restricting, the applications in the network environment may not invoke functions defined by the API 432’ and developers associated with the network environment may not access documentation related to the API 432’.

The API constructor 414 may create, produce, or otherwise generate at least one output 460 to provide to the administrator device 404. In generating the output 460, the API constructor 414 may apply or execute the generative model 428 to generate information 464 about the API specification 452’ corresponding to the API 432’. The information 464 may include a summary description about the API specification 452’. In some embodiments, the API constructor 414 may use the generative model 428 to generate information 464 corresponding to the API specification 452A and information 464 corresponding to the API specification 452B. The information 464 about the API specification 452A or 452B may include a description of a reason for selection of one of the APIs 452A or 452B, such as a broader range of functionalities or higher usage in the network environment. In some embodiments, the output 460 may include or identify the indication 462 of approval or disapproval of the API 432’. In some embodiments, when the API 432’ is determined to be not validated or to not satisfy the functionality criterion, the API constructor 414 may generate the output 460 to include an identification of which rules the API 432’ is in compliance with and which rules the API 432’ is not in compliance with.

In some embodiments, when the API 432’ is determined to not be validated or not satisfy the functionality criteria, the API constructor 414 may determine or generate a validation score for the API 432’. The validation score may be based on which subset of rules the API 432’ is not in compliance with and a remaining subset of rules the API 432’ is in compliance with. The validation score may indicate a degree of compliance with the policy 454. The API constructor 414 may generate the output 460 to include the validation score. With the generation, the API constructor 414 may provide, send, or transmit the output 460 for presentation via the user interface 408 on the administrator device 404.

The administrator device 404 may retrieve, identify, or otherwise receive the output 460 from the API management service 402. With the receipt, the administrator device 404 may render, display, or otherwise present the output 460 on the user interface 408. The administrator device 404 may present the information 464 about the API 432’ via the user interface 408. In some embodiments, the administrator device 404 may present the information 464 corresponding to the API specification 452A in one user interface element and the information 464 corresponding to the API specification 452B in another user interface element on the user interface 408. For example, the information 464 for the API specification 452A and 452B may be presented in two user interface elements in a juxtaposed manner, so that the user is presented with the summary description as well as the reason for selection of the API 432’.

In addition, the administrator device 404 may present the indication 462 included in the output 460. When the indication 462 is of approval, the administrator device 404 may present the indication 462 of approval on the user interface 408. Conversely, when the indication 462 is of disapproval, the administrator device 404 may present the indication 462 of disapproval on the user interface 408. For example, the user interface 408 may display the indication 462 of approval or disapproval with a user interface element and a set of flags to identify which rules the API 432 satisfies or did not satisfy. In addition, the user interface 408 may also display a score card using the validation score for the API 432. The user of the administrator device 404 may use the information on the user interface 408 to modify the definition of the information for the API 432 to include in the API specification 452. Upon modification of the definitions, the administrator device 404 may submit another request to validate the API 432. The process may be repeated again with the submission of the request.

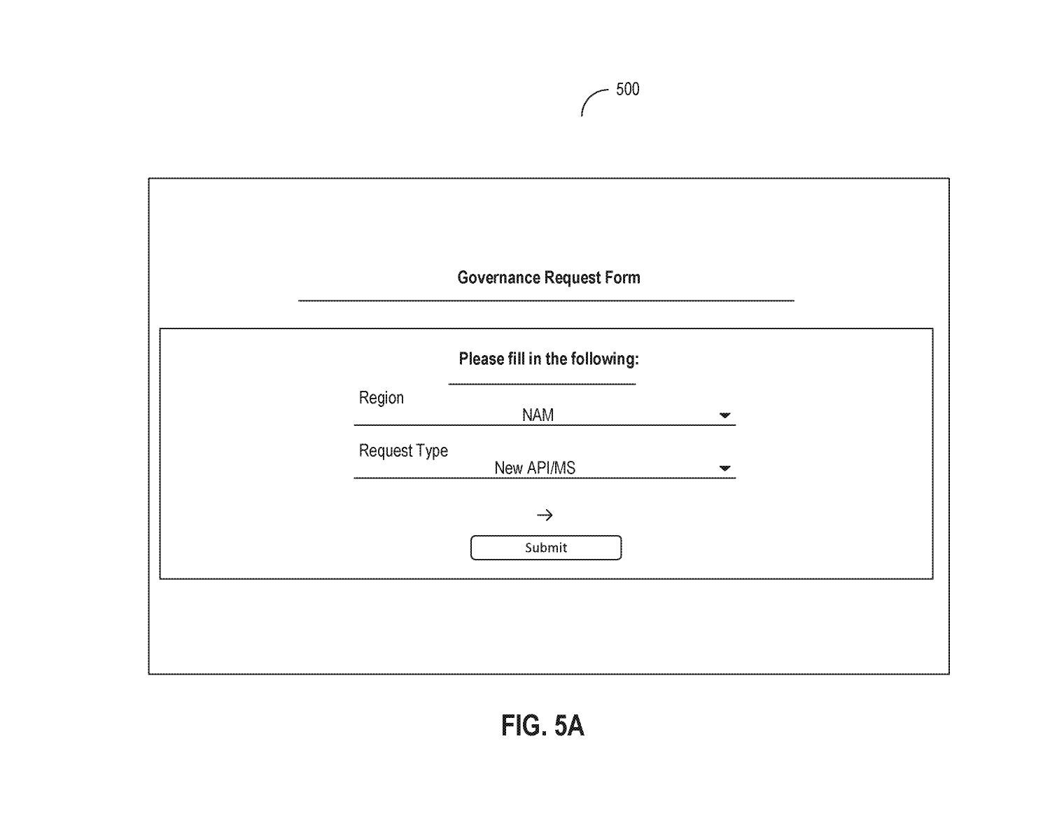

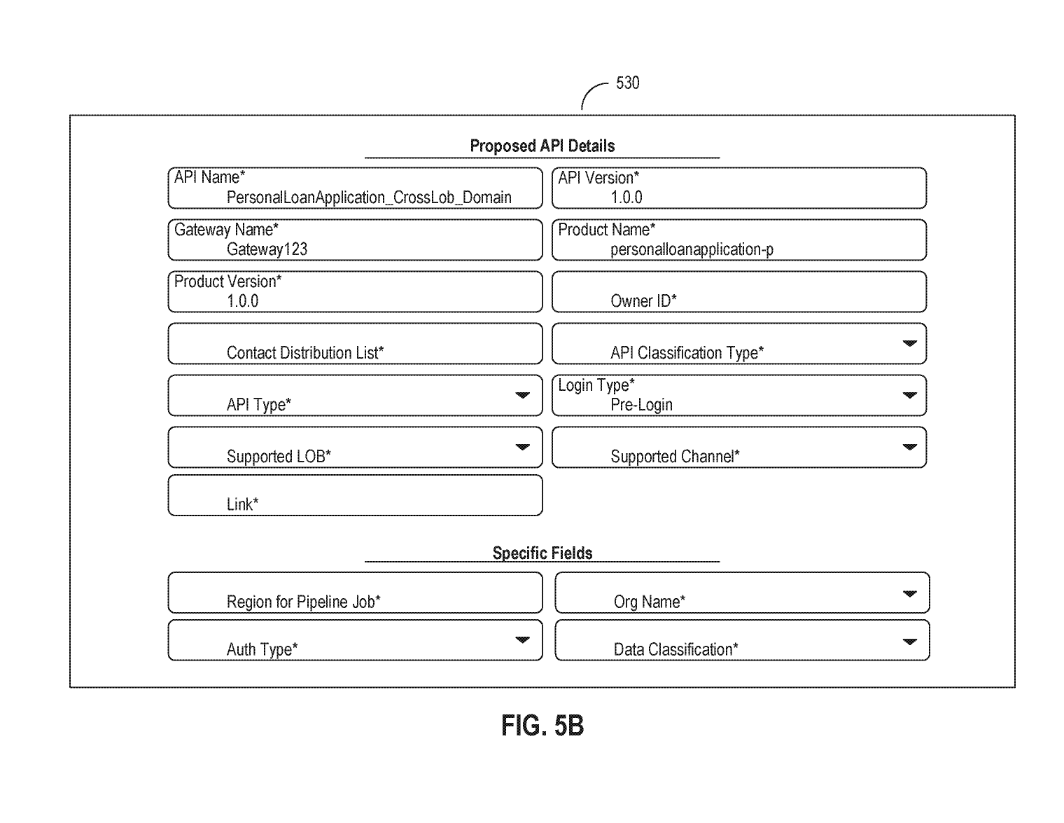

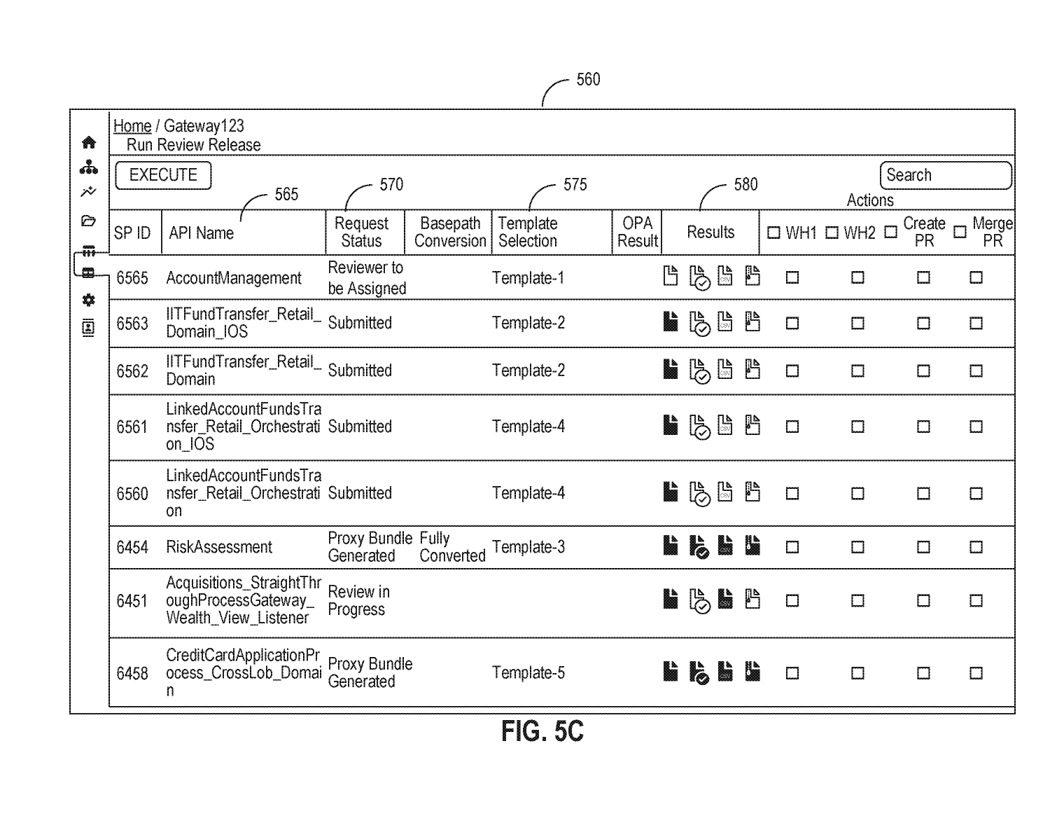

FIG. 5A illustrates a screenshot of a user interface 500 for submitting requests for application programming interfaces (APIs). The user interface 500 may be used to start a request to onboard an API for use by applications and microservices in a defined network environment, such as an enterprise network. The user interface 500 may include or identify a field for region and a request type (e.g., an addition of a new API). FIG. 5B illustrates a screenshot of a user interface 530 for inputting information on application programming interfaces (APIs) for requests. The user interface 530 may include a number of fields for entering information to define a new API for use in the defined network environment. In the depicted example, the fields may include an API name, an API version, a gateway name, a product name, a product version, an owner identifier, a contact list, an API classification type, an API type, a login type, a line of business (LOB), a channel, a link, a region, an organization name, an authorization type, and a data classification, among others. The fields may be used to construct information to define the new API to be added to the defined network environment.

FIG. 5C illustrates a screenshot of a user interface 560 for indicating results of validation and testing of application programming interfaces (APIs). The user interface 560 may be used to test, revise, and deploy (also referred to as run, review, and release) new APIs into the defined network environment. The user interface 560 may include a column 565 listing API names of new APIs under testing. The user interface 560 may include a column 570 indicating a status of testing or deployment of the new APIs. The user interface 560 may include a column 575 indicating which template was used to define and generate the API specifications for the corresponding API. The user interface 560 may include a column 580 indicating validation and testing results for the APIs. The user interface 560 may be used by the user to investigate and examine potential validation and compliance issues with APIs.

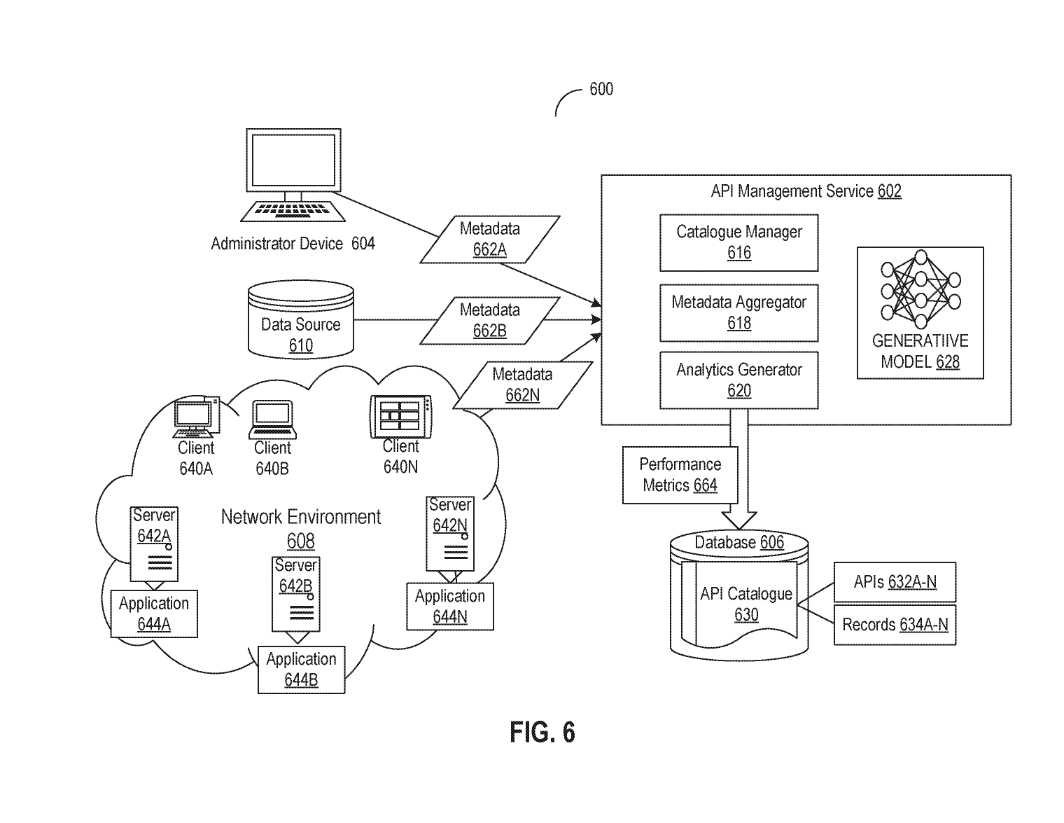

FIG. 6 illustrates a block diagram of a system 600 for aggregating metadata associated with application programming interfaces (APIs) from various data sources. The system 600 may include at least one API management server 602, at least one administrator device 604, at least one database 606, at least one network environment 608, and at least one data source 610, among others. The API management server 602 may include at least one catalogue manager 616, at least one metadata aggregator 618, at least one analytics generator 620, and at least one generative model 628, among others. The database 606 may store, maintain, or otherwise include at least one API catalogue 630. The API catalogue 630 may include or identify a set of APIs 632A–N (hereinafter generally referred to as APIs 632) and a corresponding set of records 634A–N (hereinafter generally referred to as records 634), among others. The network environment 608 may include one or more clients 640A–N (hereinafter generally referred to as client 640) and one or more servers 642A–N (hereinafter generally referred to as servers 642) hosting one or more applications 644A–N (hereinafter generally referred to as applications 644), among others. The data source 610 may be associated with the entity of the API management service 602, among others.

Embodiments may comprise additional or alternative components or omit certain components from those of FIG. 6 and still fall within the scope of this disclosure. Various hardware and software components of one or more public or private networks may interconnect the various components of the system 600. Each component in system 600 (such as the service 202, or the data processing service 205) may be any computing device comprising one or more processors coupled with memory and software, and capable of performing the various processes and tasks described herein.

The catalogue manager 616 of the API management service 602 stores and maintains the API catalogue 630 on the database 606. The API catalogue 630 may include or identify the set of APIs 632 (e.g., API specifications) and the corresponding set of records 634, among others. Each record 634 may include or identify information about the respective API 632. The record 634 may include, for example, information for the API 632 itself (e.g., an endpoint, a method, a response format, and error handling); metadata for the API 632 (e.g., a domain identifier, an API identifier, an API version, a life cycle stage, a gateway identifier, a product identifier, an owner identifier, an API type, a data classification, an authorization level, a geographical region, or organizations); and documentation for the API 632, among others. Each record 634 may define or identify at least one of a set of domains associated with the API 632. The domains may include those that the API 632 is approved for use in the network environment 608. In some embodiments, the record 634 may include information associated with the API 632 approved for use in the network environment 608. The catalogue manager 616 may update the API catalogue 630.

The metadata aggregator 618 of the API management service 602 may aggregate, collect, or otherwise retrieve metadata 662A–N (hereinafter generally referred to as metadata 662) for each API 632 on the API catalogue 630. Upon integrating or on-boarding the API 632 on the network environment 608, the metadata aggregator 618 may monitor data associated with the API 632 from various sources. The metadata 662 may be retrieved from various sources, such as the administrator device 604, the network environment 608, and the data source 610 (e.g., associated with the API management entity), among others. In some embodiments, the metadata aggregator 618 may receive the metadata 662 including usage data of the API 632 in the network environment 608. The usage data may identify or include a rate of requests, throughput, traffic patterns, distribution of devices (e.g., clients 640 or servers 642) using the API 632, response times, error rates, and authentications, among others. In some embodiments, the metadata aggregator 618 may receive the metadata 662 including a modification of the API specification from the data source 610 associated with the API management platform. In some embodiments, the metadata aggregator 618 may receive the metadata 662 including the modification of the API specification from the administrator device 604. The modification may include any changes to the information on the API 632 itself, other previously stored metadata for the API 632, or documentation for the API 632, among others.

In some embodiments, the metadata aggregator 618 may identify or determine whether the API 632 is duplicative or redundant with another API 632 based on the respective metadata 662 of the APIs 632. To determine, the metadata aggregator 618 may compare the metadata 662 of the first API 632 with the metadata 662 of the second API 632. In some embodiments, the metadata aggregator 618 may compare the record 634 (e.g., API specification) of the first API 632 with the record 634 (e.g., API specification) of the second API 632. The comparison may be facilitated using a semantic analysis, syntax comparison, functional comparison, endpoint comparison, or method analysis, among others. Based on the comparison, the metadata aggregator 618 may calculate, generate, or otherwise generate a similarity measure. The similarity measure may indicate a degree of similarity between the APIs 632. When the similarity measure satisfies (e.g., greater than or equal to) a threshold, the metadata aggregator 618 may identify or determine that the first API 632 is redundant with the second API 632. Otherwise, when the similarity measure does not satisfy (e.g., is less than) a threshold, the metadata aggregator 618 may identify or determine that the first API 632 is not redundant with the second API 632.

In some embodiments, the metadata aggregator 618 may identify or determine whether a version of the API 632 is in use or deprecated based on the usage data identified in the metadata 662 for the API 632. From the metadata 662, the metadata aggregator 618 may extract or identify the usage data for the version of the API 632. The metadata aggregator 618 may calculate, determine, or otherwise generate a usage metric based on the usage data. The usage metric may indicate a degree of use (e.g., associated with request rate and traffic patterns) of the API 632 within the network environment 608. When the usage measure satisfies (e.g., greater than or equal to) a threshold, the metadata aggregator 618 may identify or determine that the version of the API 632 is in use. Otherwise, when the usage measure does not satisfy (e.g., less than) a threshold, the metadata aggregator 618 may identify or determine that the version of the API 632 is deprecated. The metadata aggregator 618 may repeat the determination with another version of the same API 632 to select or identify a version of the API 632 to which the network environment 608 is to be migrated.

In some embodiments, the metadata aggregator 618 may determine, select, or otherwise identify a classification from a set of classifications for the API 632 based on the metadata 662. Each classification may correspond to a functionality or usage pattern of the API 632 in the network environment 608. For example, the classifications may include a data API (e.g., to provide access to data across applications 644) or a service API (e.g., to provide functionalities to different applications 644), an architecture or protocol type (e.g., representational state transfer (REST), Hypertext Transfer Protocol (HTTP), simple object access protocol (SOAP), among others). For instance, the metadata aggregator 618 may identify that the classification of the protocol type for the API 632 is REST when the modifications to the specification define REST as the protocol to be used for the API 632. The metadata aggregator 618 may parse or process the metadata 662 to extract or identify function calls or protocol types. Based on parsing the metadata 662, the metadata aggregator 618 may identify the classification for the API 632.

In some embodiments, the metadata aggregator 618 may create, write, or otherwise generate at least one graph for the API 632 using the metadata 662. The graph may be used to facilitate searching of APIs 632 from the API catalogue 630. The graph may identify or include a set of nodes and a set of edges. Each node may correspond to a respective element in the metadata 662, such as a domain identifier, an API identifier, an API version, a life cycle stage, a gateway identifier, a product identifier, an API version, an owner identifier, an API type, a data classification, an authorization level, a geographical region, or an organization, among others. Each edge may specify or define a relationship between a pair of the nodes within the graph. The edges may be directed (e.g., indicating a one-way relationship between the data elements) or undirected (e.g., indicating a two-way relationship between the corresponding pair of data elements), among others.

The analytics generator 620 of the API management service 602 creates, determines, or otherwise generates performance metrics 664 for the API 632 using the metadata 662 including usage data from the network environment 608. The performance metrics may indicate or identify various operational aspects of the API 632, and may include, for example, request rates, response time, latency, throughput, error rates, availability, and downtime, among others. The analytics generator 620 may generate the performance metrics 664 for the API 632 over a defined time period (e.g., days, weeks, months, or years) based on the metadata 662662. The analytics generator 620 may generate the performance metrics 664 as a function of the usage indicated in the metadata 662 for the API 632.

Using the metadata 662, the catalogue manager 616 may change, modify, or otherwise update the record 634 on the API catalogue 630. In some embodiments, the catalogue manager 616 may apply or execute the generative model 628 using the metadata 662. The generative model 628 may have been trained or fine-tuned using a corpus. In some embodiments, the corpus may include data related to API specifications in non-normalized form (e.g., unstructured and free text) and the API specification in normalized form (e.g., in expected, standard, or canonical form). A portion of the corpus including the API specification in the non-normalized form may be identified as a source set, and another portion of the corpus including the API specification in the normalized form may be identified as a destination set. The generative model 628 may be provided (e.g., by the API management service 602) with the source set as input and may generate an output. A distribution of the tokens in the output from the generative model 628 may be compared with a distribution of tokens in the expected output as derived from the destination set. Based on the comparison, a loss metric (e.g., cross-entry loss, a divergence loss, or mean average loss) may be calculated and the loss metric may be used to update the one or more weights in the generative model 628. To execute the generative model 628, the catalogue manager 616 may generate and provide a prompt directing the generative model 628 to generate data to add to the record 634 in canonical form (e.g., with the defined set of fields and values). The catalogue manager 616 may add the data (e.g., updated values) generated based on executing the generative model 628 to the corresponding record 634.

In some embodiments, the catalogue manager 616 may update the record 634 to include the indication of whether the API 632 is redundant with another API 632 in the network environment 608. The generative model 628 may be used to determine the presence or absence of redundancy between APIs 632 (e.g., using the set of embeddings derived from the data). The record 634 may include an identification of two or more APIs 632 identified as redundant. In some embodiments, the catalogue manager 616 may update the record 634 to include an indication of whether the version of the API 632 is in use or deprecated. If deprecated, the catalogue manager 616 may also update the record 634 to include an identification of another version of the API 632 in use. In some embodiments, the catalogue manager 616 may update the record 634 to include the classification for the API 632. In some embodiments, the catalogue manager 616 may update the record 634 to include the graph generated using the metadata 662 for the API 632. In some embodiments, the catalogue manager 616 may update the record 634 to include the performance metrics 664. The catalogue manager 616 may update the records 634 on the API catalogue 630 as more and more metadata 662 is aggregated from the various data sources.

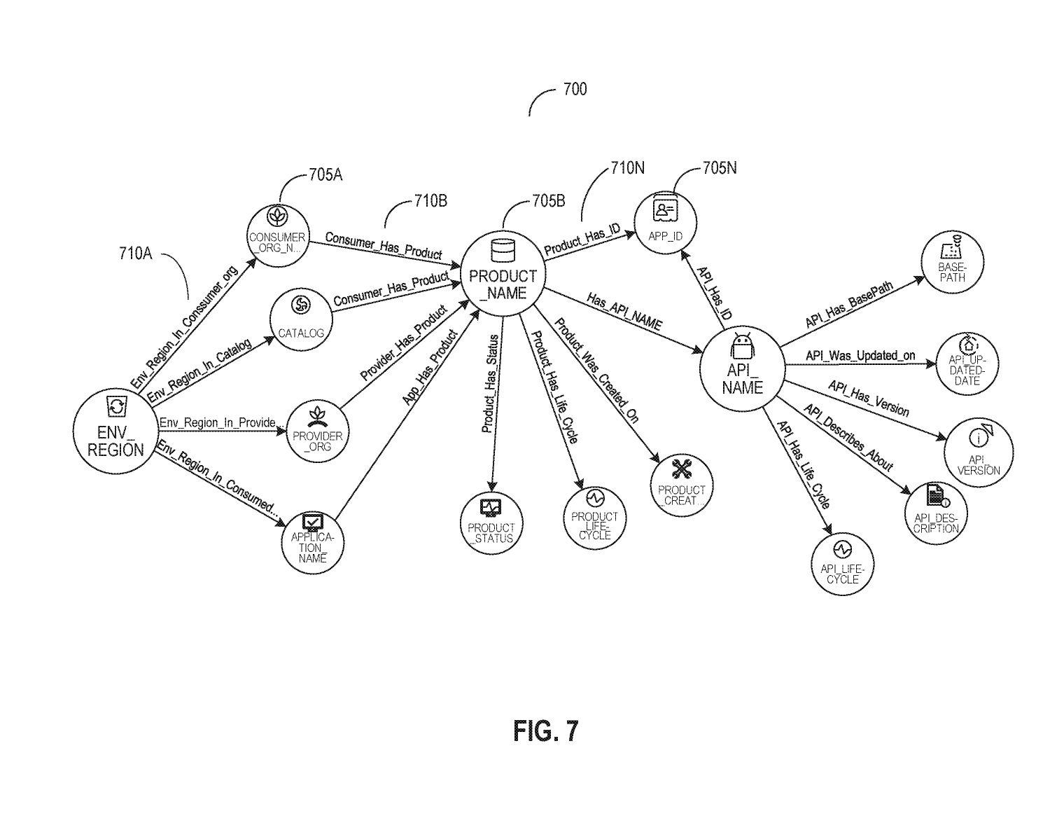

FIG. 7 illustrates a block diagram of a graph 700 for data elements in metadata associated with application programming interfaces (APIs) from various data sources. The graph 700 may identify or include a set of nodes 705A–N (hereinafter generally referred to as nodes 705) and a set of edges 710A–N (hereinafter generally referred to as edges 710), among others. The graph 700 may have been generated using metadata for an API. Each node 705 may correspond to a data element in the metadata associated with the API, such as a region, a provider identifier, an application name, a consumer organization, a product name, a product status, a product life cycle identification, a production, an application identifier, an operating system name, a base path, an update timestamp, an API version, an API documentation, and an API lifecycle, among others. The edges 710 in the graph 700 may be directional and may specify a relationship among the data elements for the corresponding nodes 705.

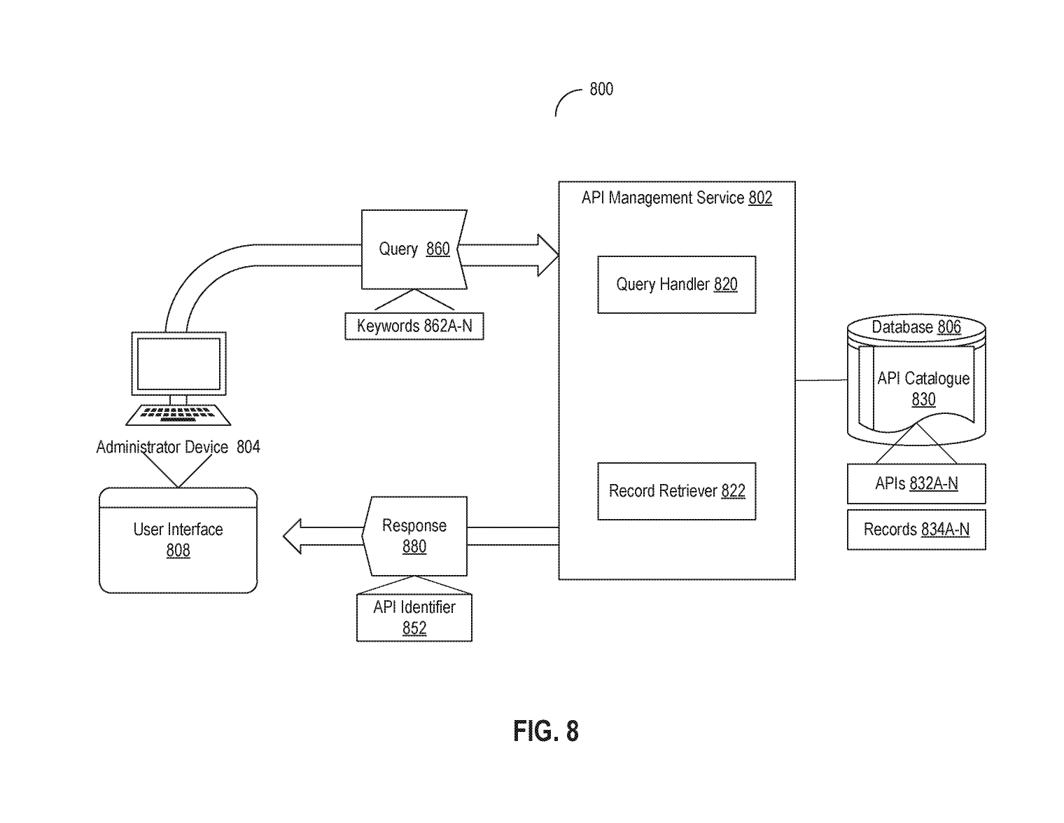

FIG. 8 illustrates a block diagram of a system 800 for accessing application programming interface (API) catalogues used in network environments. The system 800 may include at least one API management service 802, at least one administrator device 804, and at least one database 806, among others. The API management service 802 may include at least one query handler 820 and at least one record retriever 822, among others. The administrator device 804 may provide at least one user interface 808. The database 806 may store, maintain, or otherwise include at least one API catalogue 830. The API catalogue 830 may identify or include a set of APIs 832A–N (hereinafter generally referred to as APIs 832) and a corresponding set of records 834A–N (hereinafter generally referred to as records 834), among others.

Embodiments may comprise additional or alternative components or omit certain components from those of FIG. 8 and still fall within the scope of this disclosure. Various hardware and software components of one or more public or private networks may interconnect the various components of the system 800. Each component in the system 800 (such as the service 202, or the data processing service 205) may be any computing device comprising one or more processors coupled with memory and software, and capable of performing the various processes and tasks described herein.

The query handler 820 of the API management service 802 may send, transmit, or otherwise provide the user interface 808 to the administrator device 804. In some embodiments, the query handler 820 may transmit or send an instruction to display, render, or otherwise present the user interface 808 via the administrator device 804. The user interface 808 may be a graphical user interface of an application (e.g., web application) supported by the API management service 302. The user interface 808 may include one or more fields (e.g., user interface elements) for searching for APIs 832 from the catalogue 830. For example, the fields may include or identify a domain, a functionality, an application, a version, a classification, or any metadata detailed herein associated with the API 832. In some embodiments, the query handler 820 may execute a chatbot using machine learning, artificial intelligence (AI) algorithms, or rules-based systems, among others. The chatbot may simulate conversation with the user on the administrator device 804 to accept input from the user and to generate outputs indicating search query results to the user. The user interface 808 may be a chat interface (e.g., as part of a conversation interface) to enter input for the chatbot.

The administrator device 804 may retrieve, obtain, or otherwise receive the user interface 808 from the API management service 802. For instance, the administrator device 804 may receive the instruction for presentation of the user interface 808 from the API management service 802. With the receipt, the administrator device 804 may present the user interface 808 via a display and may accept user inputs on the user interface 808. Using the information inputted on the user interface 808, the administrator device 804 may create, write, or otherwise generate at least one query 860. The query 860 may identify or include one or more keywords 862A–N (hereinafter generally referred to as keywords 862) to be used to find APIs 832. The query 860 (or at least one of the keywords 862) may identify at least one domain to be searched for the APIs 832. In some embodiments, the query 860 may be generated using input on the chat interface (e.g., conversational interface).

The query handler 820 may retrieve, identify, or otherwise receive the query 860 from the administrator device 804. With receipt, the query handler 820 may process or parse the query 860 to extract or identify the keywords 862 from the query 860. In some embodiments, the query handler 820 may identify the keywords 862 from the inputs on the chat interface for the chatbot. In some embodiments, the query handler 820 may identify the domain to be searched from the query 860. With the identification, the query handler 820 may produce or generate additional keywords in accordance with keyword expansion. The generation of additional keywords may be in accordance with a semantic graph identifying related keywords and phrases.

Based on the keywords 862 of the query 860 and the records 834 (or metadata), the record retriever 822 may identify or select one or more records 834 for the corresponding APIs 832 from the API catalogue 830. The selection may be based on the keywords 862 matching or corresponding with at least a portion of the records 834. The record retriever 822 may use a search engine or algorithm to select the records 834. In some embodiments, the record retriever 822 may select an initial set of records 834 for the corresponding APIs 832 based on the domain identified in the query 860. From the initial set, the record retriever 822 may use the keywords 862 to select the one or more records 834. In some embodiments, the record retriever 822 may select the record 834 using the keywords 862 and the graphs in the records 834. For instance, the record retriever 822 may select the records 834 based on the keywords 862 matching nodes in the graphs of the records 834.

With the selection, the record retriever 822 may produce, output, or otherwise transmit at least one response 880 to provide to the administrator device 804. The response 880 may identify or include at least one API identifier 852. The API identifier 852 may identify a respective record 834 and by extension the corresponding API 832 from the API catalogue 830. In some embodiments, the record retriever 822 may generate the response 880 to include information associated with the API 832, such as the performance metrics, the API specification, metadata, and domains, among others. With the generation, the record retriever 822 may provide, send, or otherwise transmit the response 880 to the administrator device 804 for presentation on the user interface 808. The administrator device 804 may retrieve, identify, or otherwise receive the response 880 from the API management service 802. With receipt, the administrator device 804 may render, display, or otherwise present the API identifier 852 on the user interface 808. In some embodiments, the administrator device 804 may present the information associated with the API 832, such as the performance metrics, the API specification, metadata, and domains, among others.

In this manner, the API management service may provide for centralized records of APIs available for use in the network environment. The use of templates for API specifications may improve consistency of and standardize API-related information. By controlling integration of APIs into the network environment, the service may further ensure that the API specification is successfully validated and tested prior to the integration. The continuous monitoring by the service may allow for lifecycle management of the APIs from development, deployment, versioning, and deprecation. The centralized catalogue may also provide a consistent and standardized information about APIs as well as performance metrics of the APIs used in the network environment. With the improvement in the API governance for the network environment, the computing resources and network bandwidth of the servers and clients in the network environment may be more efficiently allocated. Furthermore, new APIs may be deployed in a standard and consistent manner, thereby increasing the adaptation of newer functionality in the network environment.

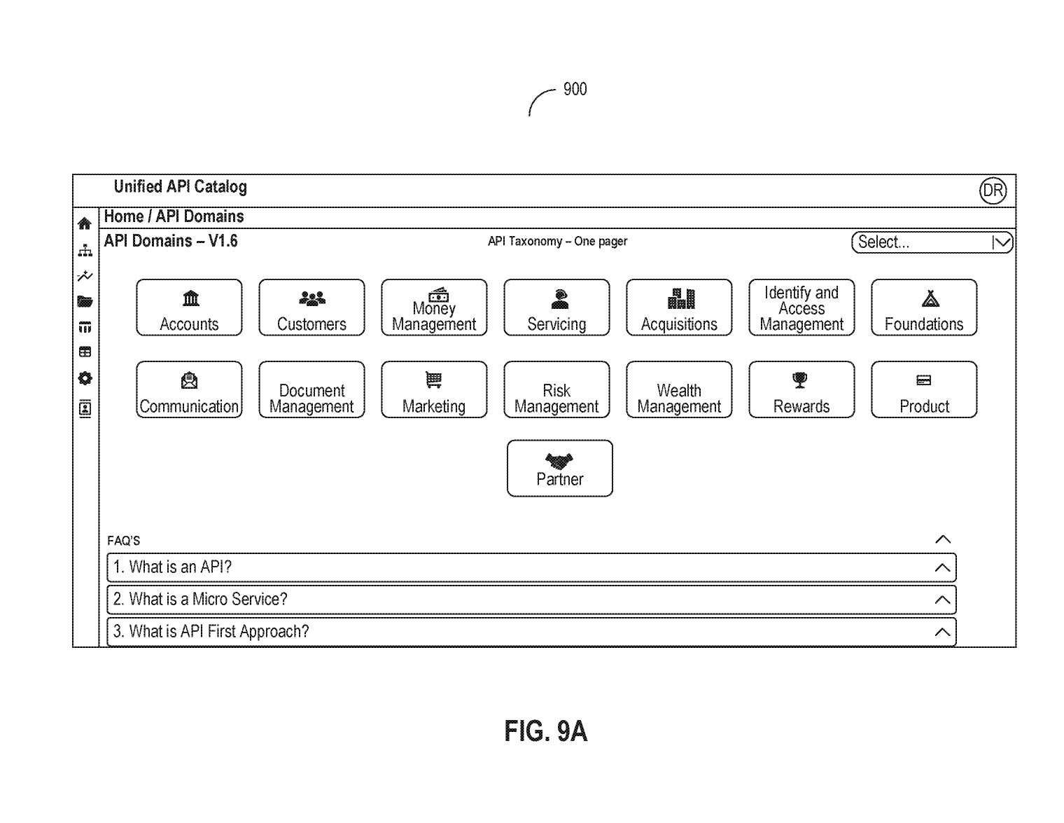

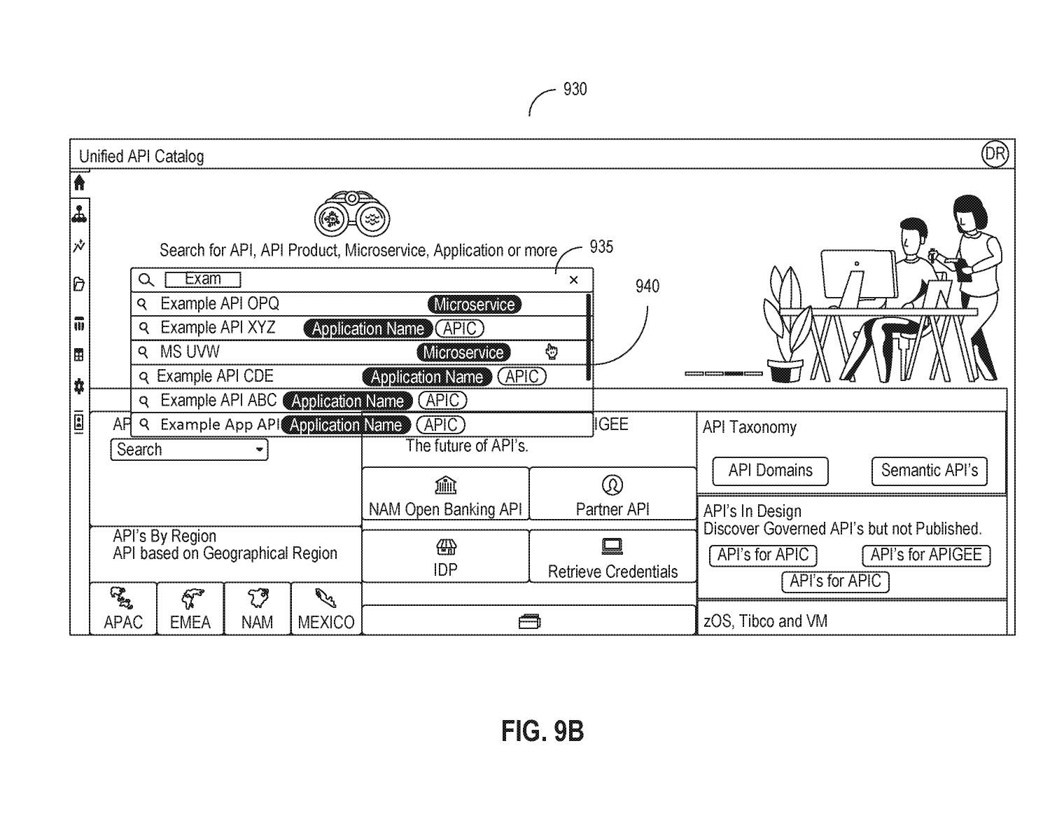

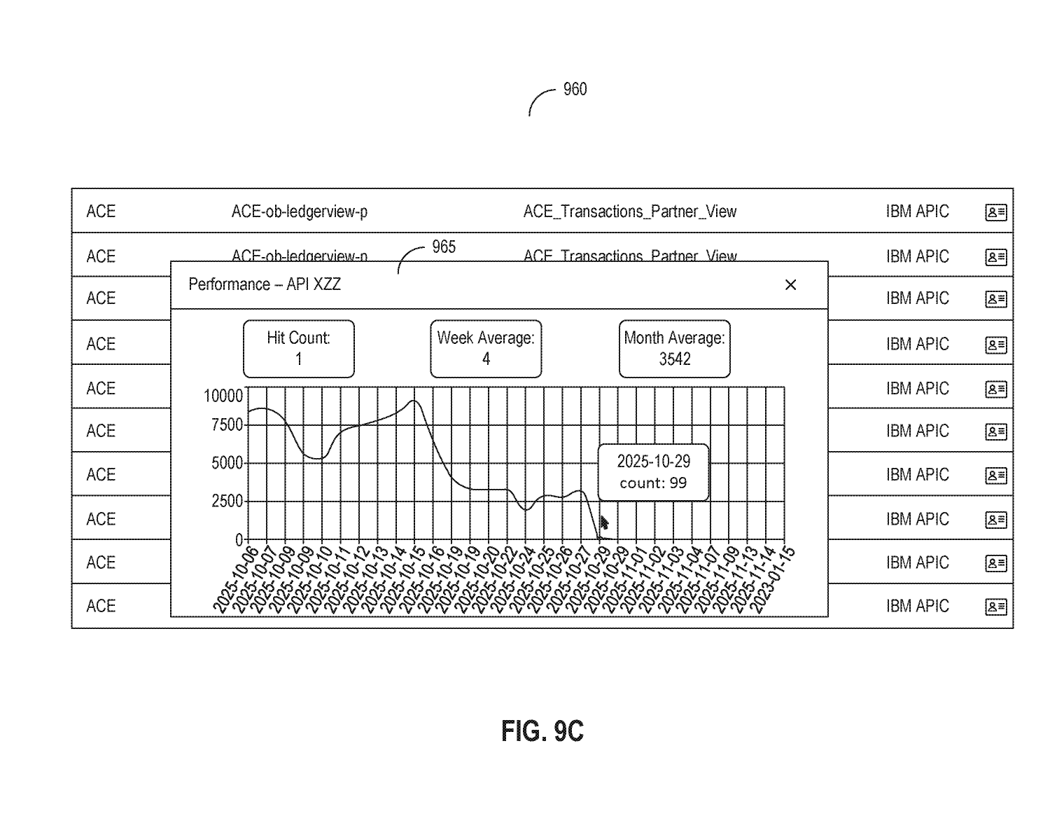

FIG. 9A illustrates a screenshot of a user interface 900 with a list of domains for application programming interface (API) catalogues. The user interface 900 may include a list of API taxonomies (or domains), such as accounts, customers, money management, servicing, acquisitions, access management, foundations, communications, document management, marketing, wealth management, rewards, products, and partnerships, among others. The user may select one of the taxonomies on the user interface 900 to view which APIs are available in each taxonomy.

FIG. 9B illustrates a screenshot of a user interface 930 to search application programming interface (API) catalogues. The user interface 930 may be the graphical user interface for querying the API catalogue. The user interface 930 may include at least one search field 935 to enter one or more keywords. As the user types in the keywords for searching the API catalogue, the user interface 930 may display a list of results 940. The list of results 940 may identify a set of APIs corresponding to the keywords. The user may select one of the results to view further information about the API. FIG. 9C illustrates a screenshot of a user interface 960 including performance metrics for application programming interfaces (APIs). The user interface 960 may include at least one performance metrics window 965. The performance metrics window 965 may include usage of the given API (e.g., “API XZZ”) across time.

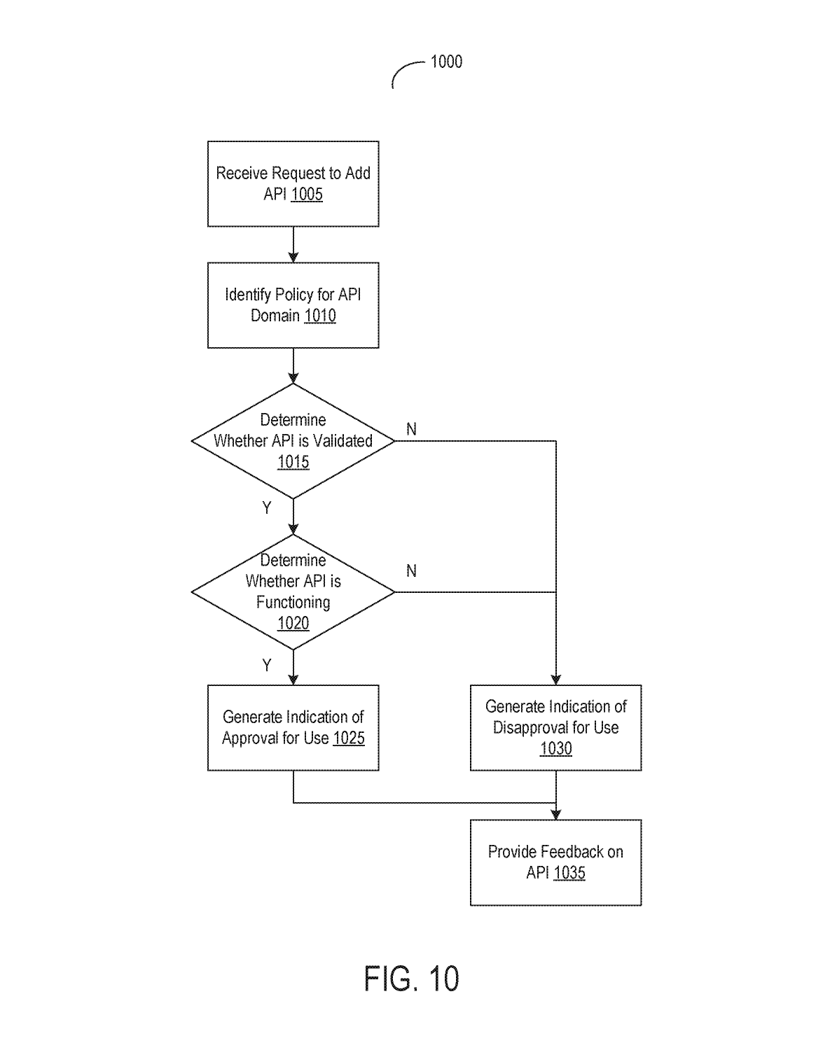

FIG. 10 illustrates a flow diagram of a method 1000 for integrating application programming interfaces (APIs) for use in networked environments. The method 1000 may be performed by a service (e.g., an API management service) executing machine-readable software code, though it should be appreciated that the various operations may be performed by one or more computing devices and/or processors. At step 1005, a service may receive a request to add an API. The request may identify information defining the API to be added to a network environment. The request may identify a domain (e.g., an application or function type) for the API. The information may be generated from data inputted onto a dashboard interface.

At step 1010, the service may identify a policy for the API domain from a set of domains. Upon receipt, the service may parse the request to identify the domain associated with the API. The service may select the policy from a set of policies associated with the domain. Each policy may specify a set of rules for validating the API and performance criteria for the API to be approved for addition to the network environment. At step 1015, the service may determine whether the API is validated in accordance with the policy. The service may run a validation test on the API in accordance with the set of rules of the policy for validation. At step 1020, if the API is determined to be validated, the service may determine whether the API is properly functioning. The service may run a performance test on the API in accordance with the set of rules of the policy for performance.

At step 1025, when the API is determined to be validated and to be properly functioning, the service may generate an indication of approval for use. The service may perform on-boarding and integration of the API into the network environment, by permitting applications and services in the network environment to invoke functions defined by the API. At step 1030, when the API is determined to be not validated or not properly functioning, the service may generate an indication of disapproval for use. The service may also restrict the API from use in the network environment. At step 1035, the service may provide feedback on the API based on the indication. The feedback may include the indication of approval or disapproval of the API. The service may also generate the feedback to include which rules the API was not compliant with.

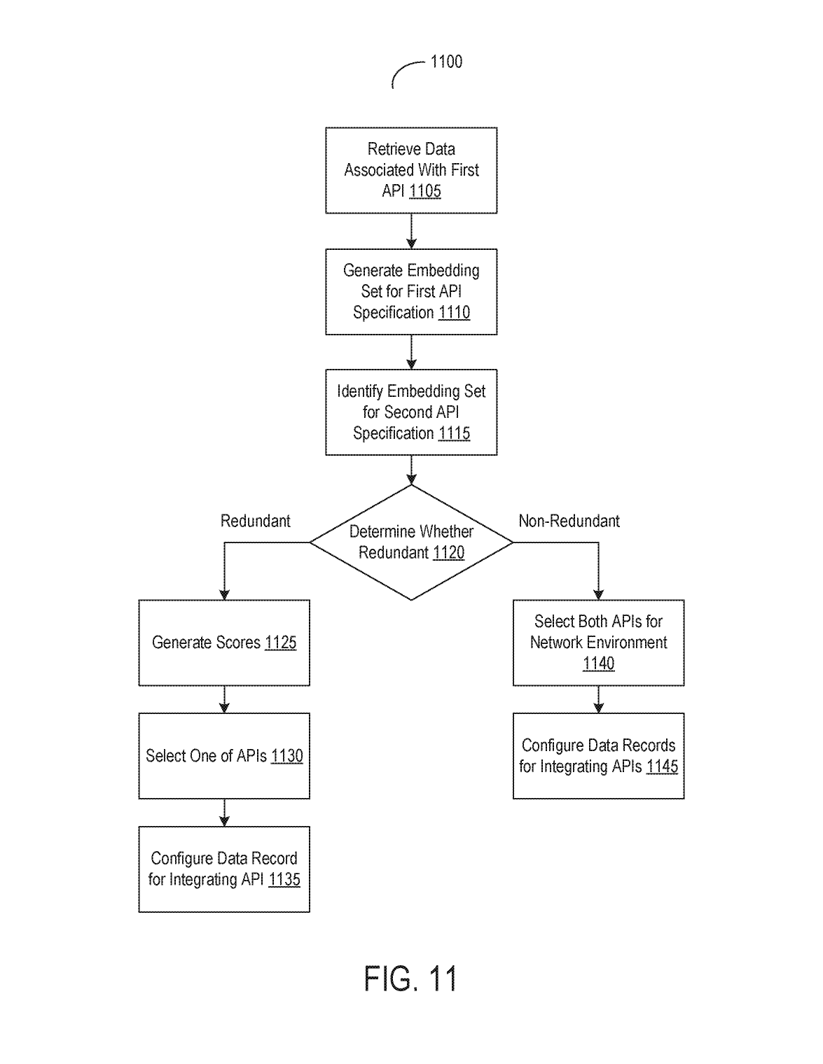

FIG. 11 illustrates a flow diagram of a method 1100 for selecting application programming interfaces (APIs) for use in network environments. The method 1100 may be performed by a service (e.g., an API management service) executing machine-readable software code, though it should be appreciated that the various operations may be performed by one or more computing devices and/or processors. At step 1105, a service may retrieve data associated with a first API from a network environment. The data may include portions of an API specification, transaction logs for invocation of functions available through the first API, or a domain policy for the API, among others. At step 1110, the service may generate a set of embeddings for the first API specification by applying a generative model on the data. From applying the generative model, the service may generate the first API specification from the data. In generating the first API specification, the service may derive or extract the set of embeddings. The set of embeddings may be a lower-dimensional, encoded representation of the first API specification.

At step 1115, the service may identify a set of embeddings for a second API specification. The second API specification may be stored and maintained on a database. The service may generate the set of embeddings for the second API specification by applying a generative model on the second API specification. From applying, the service may derive or extract the set of embeddings. The set of embeddings may be a lower-dimensional, encoded representation of the first API specification. At step 1120, the service may determine whether the first and second APIs are redundant based on a comparison of the sets of embeddings for the first and second API specifications respectively. To compare, the service may calculate a distance between the values of the sets of embeddings. If the distance is greater than a threshold, the service may determine that the first and second APIs are not redundant. In contrast, if the distance is less than or equal to the threshold, the service may determine that the first and second APIs are redundant.

When the first and second APIs are determined to be redundant, at step 1125, the service may generate scores for the first and second APIs, respectively, using the generative model. Each score may indicate the degree of capabilities of the respective API. At step 1130, the service may select one of the APIs based on the score. For instance, the service may select the API with the highest score. At step 1135, the service may configure a data record to indicate the selected API as permitted to be used in the network environment. Conversely, when the first and second APIs are determined to be not redundant, at step 1140, the service may select both the first and second APIs for the network environment. At step 1145, the service may configure data records to indicate that both the first and second APIs are permitted to be used in the network environment.

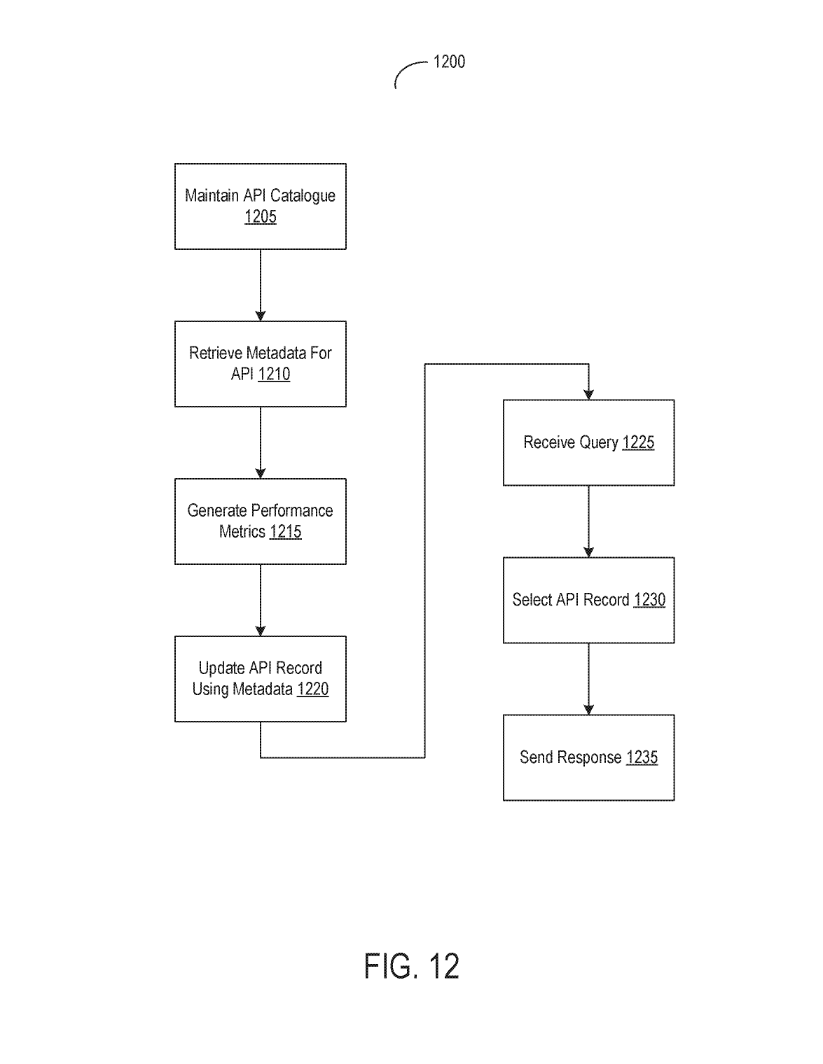

FIG. 12 illustrates a flow diagram of a method 1200 for cataloguing application programming interfaces (APIs) using metadata. The method 1200 may be performed by a service (e.g., an API management service) executing machine-readable software code, though it should be appreciated that the various operations may be performed by one or more computing devices and/or processors. At step 1205, a service may maintain an API catalogue. The API catalogue may include a set of API records for a corresponding set of APIs. Each record may contain information associated with the API, such as the specification, metadata, and domain, among others. The information may be standardized across each associated domain in accordance with a template for the catalogue.

At step 1210, the service may retrieve metadata for each API on the API catalogue. Once the API is integrated into a defined network environment, the service may monitor the metadata for the API from various sources, such as the clients, servers, and applications in the network environment, the administrator of the network or APIs, and the API management platform, among others. The metadata may indicate usage of the API within the network environment. At step 1215, the service may generate performance metrics based on the usage of the API within the network environment. The performance metrics may include, for example, request rates, response time, latency, throughput, error rates, availability, and downtime, among others. At step 1220, the service may update the API record using the metadata retrieved for the API. The service may update the API record to include performance metrics, classification, version deprecation, and redundancies, among others.

At step 1225, the service may receive a query to find APIs from the API catalogue. The query may include one or more keywords. The query may identify a domain associated with the API. Upon receipt, the service may parse the query to extract or identify the keywords. At step 1230, the service may select one or more API records from the API catalogue using the keywords of the query. The service may search the API catalogue to find API records corresponding to the keywords. At step 1235, the service may send a response to identify the API records corresponding to the keywords. The service may include information about the API (e.g., API specification, metadata, performance metrics) in the response.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of configuring data records of application programming interface (API) specifications for applications in network environments, comprising:
retrieving, by one or more processors, from a network environment, data associated with a first API for a first plurality of functions available for invocation to one or more applications in the network environment;
executing, by the one or more processors, a generative model using the data associated with the first API to generate a first plurality of embeddings corresponding to a first API specification that at least partially defines the first plurality of functions;
identifying, by the one or more processors, from a database, a second plurality of embeddings corresponding to a second API specification for a second API that defines a second plurality of functions available for invocation to the one or more applications;
determining, by the one or more processors, a redundancy between the first API specification and the second API specification using the first plurality of embeddings and the second plurality of embeddings;
selecting, by the one or more processors, responsive to determining the redundancy, an API from one of the first API and the second API based on a comparison between the first plurality of functions of the first API and the second plurality of functions of the second API; and
configuring, by the one or more processors, on the database, a data record identifying the API as permitted for use by the one or more applications in the network environment.

2. The method of claim 1, further comprising:
determining, by the one or more processors, a lack of redundancy between a third API specification and a fourth API specification using a third plurality of embeddings corresponding to the third API specification and a fourth plurality of embeddings corresponding to the fourth API specification;
selecting, by the one or more processors, responsive to determining the lack of redundancy, the third API and the fourth API to permit for use in the network environment; and
configuring, by the one or more processors, on the database, a second data record identifying the third API and the fourth API as permitted for use in the network environment.

3. The method of claim 1, wherein executing the generative model further comprises:
creating, using the data associated with the first API, a data structure for the first API specification comprising a plurality of fields and a corresponding plurality of values in accordance with a canonical form, to define the first plurality of functions available for invocation to one or more applications;
identifying, from the plurality of fields of the data structure, a field corresponding to a missing value in the plurality of values; and
generating, based on the data associated with the first API, a value corresponding to the field to include in the plurality of values, and
wherein configuring the data record further comprising storing the data structure for the API specification.

4. The method of claim 1, wherein executing the generative model further comprises:
creating, using the data associated with the first API, an output comprising a summarization for the first API specification defining the first plurality of functions available for invocation to one or more applications via the first API; and
generating the first plurality of embeddings corresponding to the summarization of the output.

5. The method of claim 1, further comprising:
executing, by the one or more processors, using the first plurality of embeddings and the second plurality of embeddings, a clustering model comprising a plurality of clusters defined within a feature space;
determining, by the one or more processors, based on executing the clustering model, (i) a first cluster assignment corresponding to at least one of the plurality of clusters for the first plurality of embeddings and (ii) a second cluster assignment corresponding to at least one of the plurality of clusters for the second plurality of embeddings,
wherein determining the redundancy further comprises determining the redundancy between the first API specification and the second API specification based on the first cluster assignment and the second cluster assignment.

6. The method of claim 1, further comprising generating, by the one or more processors responsive to determining the redundancy, using the generative model, (i) a first score indicating capability of the first plurality of functions of the first API and (ii) a second score indicating capability of the second plurality of functions of the second API,
wherein selecting the API further comprises selecting the API from one of the first API and the second API based the comparison between the first score and the second score.

7. The method of claim 1, further comprising:
generating, by the one or more processors, using the generative model, (i) first information corresponding to the first API specification and (ii) second information corresponding to the second API specification; and
providing, by the one or more processors, via a user interface, at least one of (i) a first interface element to present the first information or (ii) a second interface element to present the second information.

8. The method of claim 1, further comprising:
identifying, by the one or more processors, a domain policy defining applicability of the API specification to a region in the network environment;
generating, by the one or more processors, in accordance with the domain policy, a tag to include with a data structure for the API specification to define the applicability to the region; and
updating, by the one or more processors, based on executing the generative model using the tag, one or more values in the data structure,
wherein storing the data record further comprises configuring the data record identifying the API as permitted for use in the region in accordance with the domain policy.

9. The method of claim 1, further comprising:
generating, by the one or more processors, based on executing the generative model using the API specification, (i) a test schema defining a test case for at least one function of a plurality of functions of the API and (ii) test data with which to evaluate the test case; and
executing, by the one or more processors, in accordance with the test schema, the test case to invoke the at least one function using the test data to generate a data result; and
storing, by the one or more processors, on the database, an association between the test result and the data record for the API.

10. The method of claim 1, wherein retrieving the data associated with the first API further comprises retrieving the data comprising at least one of: (i) at least a portion of the first API specification, (ii) a transaction log for invocation of the first plurality of functions, or (iii) a domain policy.

11. A system for configuring data records of application programming interface (API) specifications for applications in network environments, comprising:
one or more processors coupled with a non-transitory memory, configured to:
retrieve from a network environment, data associated with a first API for a first plurality of functions available for invocation to one or more applications in the network environment;
execute a generative model using the data associated with the first API to generate a first plurality of embeddings corresponding to a first API specification that at least partially defines the first plurality of functions;
identify, from a database, a second plurality of embeddings corresponding to a second API specification for a second API that defines a second plurality of functions available for invocation to the one or more applications;
determine a redundancy between the first API specification and the second API specification using the first plurality of embeddings and the second plurality of embeddings;
select, responsive to determining the redundancy, an API from one of the first API and the second API based on a comparison between the first plurality of functions of the first API and the second plurality of functions of the second API; and
configure, on the database, a data record identifying the API as permitted for use by the one or more applications in the network environment.

12. The system of claim 11, wherein the one or more processors are further configured to:
determine a lack of redundancy between a third API specification and a fourth API specification using a third plurality of embeddings corresponding to the third API specification and a fourth plurality of embeddings corresponding to the fourth API specification;
selective, responsive to determining the lack of redundancy, the third API and the fourth API to permit for use in the network environment; and
configure, on the database, a second data record identifying the third API and the fourth API as permitted for use in the network environment.

13. The system of claim 11, wherein the one or more processors are further configured to execute the generative model to:
create, using the data associated with the first API, a data structure for the first API specification comprising a plurality of fields and a corresponding plurality of values in accordance with a canonical form, to define the first plurality of functions available for invocation to one or more applications;
identify, from the plurality of fields of the data structure, a field corresponding to a missing value in the plurality of values; and
generate, based on the data associated with the first API, a value corresponding to the field to include in the plurality of values, and
configure the data structure by storing the data structure for the API specification.

14. The system of claim 11, wherein the one or more processors are further configured to execute the generative model to:
create, using the data associated with the first API, an output comprising a summarization for the first API specification defining the first plurality of functions available for invocation to one or more applications via the first API; and
generate the first plurality of embeddings corresponding to the summarization of the output.

15. The system of claim 11, wherein the one or more processors are further configured to:
execute using the first plurality of embeddings and the second plurality of embeddings, a clustering model comprising a plurality of clusters defined within a feature space;
determine, based on executing the clustering model, (i) a first cluster assignment corresponding to at least one of the plurality of clusters for the first plurality of embeddings and (ii) a second cluster assignment corresponding to at least one of the plurality of clusters for the second plurality of embeddings; and
determine the redundancy between the first API specification and the second API specification based on the first cluster assignment and the second cluster assignment.

16. The system of claim 11, wherein the one or more processors are further configured to:
generate, responsive to determining the redundancy, using the generative model, (i) a first score indicating capability of the first plurality of functions of the first API and (ii) a second score indicating capability of the second plurality of functions of the second API,
select the API from one of the first API and the second API based the comparison between the first score and the second score.

17. The system of claim 11, wherein the one or more processors are further configured to:
generate, using the generative model, (i) first information corresponding to the first API specification and (ii) second information corresponding to the second API specification; and
provide, via a user interface, at least one of (i) a first interface element to present the first information or (ii) a second interface element to present the second information.

18. The system of claim 11, wherein the one or more processors are further configured to:
identify a domain policy defining applicability of the API specification to a region in the network environment;
generate, in accordance with the domain policy, a tag to include with a data structure for the API specification to define the applicability to the region; and
update, based on executing the generative model using the tag, one or more values in the data structure,
configure the data record identifying the API as permitted for use in the region in accordance with the domain policy.

19. The system of claim 11, wherein the one or more processors are further configured to:
generate, based on executing the generative model using the API specification, (i) a test schema defining a test case for at least one function of a plurality of functions of the API and (ii) test data with which to evaluate the test case; and
execute, in accordance with the test schema, the test case to invoke the at least one function using the test data to generate a data result; and
store, on the database, an association between the test result and the data record for the API.

20. The system of claim 11, wherein the one or more processors are further configured to retrieve the data comprising at least one of: (i) at least a portion of the first API specification, (ii) a transaction log for invocation of the first plurality of functions, or (iii) a domain policy.
